(19) United States
(12) Patent Application Publication
(10) Pub. No.: US 2024/0253341 A1
(43) Pub. Date: Aug. 1, 2024

(54) SHEET PROCESSING SYSTEM

(71) Applicants: Kazuki SHIMODATE, Kanagawa (JP); Naoki TAKAI, Tokyo (JP); Yuichiro KATO, Kanagawa (JP); Sho ASANO, Kanagawa (JP); Ruki MIDORIKAWA, Kanagawa (JP); Yosuke SAITO, Kanagawa (JP)

(72) Inventors: Kazuki SHIMODATE, Kanagawa (JP); Naoki TAKAI, Tokyo (JP); Yuichiro KATO, Kanagawa (JP); Sho ASANO, Kanagawa (JP); Ruki MIDORIKAWA, Kanagawa (JP); Yosuke SAITO, Kanagawa (JP)

(73) Assignee: Ricoh Company, Ltd., Tokyo (JP)

(21) Appl. No.: 18/416,393

(22) Filed: Jan. 18, 2024

(30) Foreign Application Priority Data
Jan. 27, 2023 (JP) 2023-010919
Feb. 10, 2023 (JP) 2023-018970

(51) Int. Cl. B32B 37/10; B32B 37/12; B32B 38/00; B32B 38/18

(52) U.S. Cl. CPC B32B 37/1045; B32B 38/004; B32B 38/1808; B32B 2037/1215

(57) ABSTRACT

A sheet processing system includes a sheet processing device and a lamination processing device. The sheet processing device includes a sheet separator that separates a two-ply sheet and inserts an inner sheet between the two-ply sheet to form a first enclosed two-ply sheet. The lamination processing device bonds the first enclosed two-ply sheet, and bonds a second enclosed two-ply sheet in which the inner sheet is inserted outside the sheet separator. The sheet processing system includes a relay conveyor that conveys the first enclosed two-ply sheet from the sheet separator to the lamination processing device attachable to a sheet feeder to directly feed the second enclosed two-ply sheet to the lamination processing device. The sheet processing device includes a cord holder to hold the power cord of the lamination processing device at a position where feeding and ejecting the two-ply sheet after bonding the two-ply sheet are not hindered.

### CROSS-REFERENCE TO RELATED APPLICATIONS

This patent application is based on and claims priority pursuant to 35 U.S.C. § 119(a) to Japanese Patent Application Nos. 2023-010919, filed on Jan. 27, 2023, and 2023-018970, filed on Feb. 10, 2023, in the Japan Patent Office, the entire disclosure of each of which is hereby incorporated by reference herein.

### BACKGROUND

### Technical Field

Embodiments of the present disclosure relate to a sheet processing system that performs a sheet laminating operation on a two-ply sheet including two sheets and having an inner sheet inserted between the two sheets.

### Background Art

Various types of sheet processing systems are known that include a sheet separation device that separates a two-ply sheet in which two sheets are overlapped and bonded together at bonding portions and an inner sheet is inserted between the two sheets separated from each other, and a sheet lamination device that perform a sheet laminating operation on the two-ply sheet conveyed from the sheet separation device.

Such sheet processing systems automatically and sequentially perform a sheet separating operation to separate two sheets of a two-ply sheet, a sheet inserting operation to insert an inner sheet between the two sheets of the two-ply sheet after the sheet separating operation, and a sheet laminating operation to bond the two sheets of the two-ply sheet after the sheet inserting operation.

Typical sheet processing systems have limited sizes and thicknesses of sheets on which a series of sheet separating operation, sheet inserting operation, and sheet laminating operation are automatically performed. Due to such a configuration, a desired sheet process cannot be performed on sheets having sizes and thicknesses outside a predetermined range, which is inconvenient for a user.

On the other hand, typical sheet laminators (lamination processing devices) perform lamination independently and include a guide rib for winding a power cord.

A typical lamination processing device is detachably attached to a sheet processing device including a sheet separator in order to use the lamination processing device as a stand-alone device. In such a case, when a lamination processing device is attached to a sheet processing device, a power cord of the lamination processing device is sandwiched between the lamination processing device and the sheet processing device or the power cord of the lamination processing device hinders a sheet feeding operation of a sheet in the sheet processing device or a sheet ejection operation of a two-ply sheet from the lamination processing device.

### SUMMARY

Embodiments of the present disclosure described herein provide a novel sheet processing system including a sheet processing device, a lamination processing device, and a relay conveyor. The sheet processing device includes a sheet separator to separate a non-bonding portion of a two-ply sheet having two sheets overlapped and bonded together at a bonding portion, and insert an inner sheet between the two sheets of the two-ply sheet separated to form a first enclosed two-ply sheet. The lamination processing device bonds the two sheets of the first enclosed two-ply sheet, and bonds the two sheets of a second enclosed two-ply sheet in which the inner sheet is inserted between the two sheets of the second enclosed two-ply sheet disposed outside the sheet separator. The relay conveyor is disposed downstream from the sheet separator and upstream from the lamination processing device in a sheet conveyance direction to convey the first enclosed two-ply sheet from the sheet separator to the lamination processing device. The lamination processing device is attachable a sheet feeder to directly feed the second enclosed two-ply sheet to the lamination processing device.

Further, embodiments of the present disclosure described herein provide a novel sheet processing system including a sheet processing device and a lamination processing device. The sheet processing device includes a sheet separator and a cord holder. The sheet separator separates a non-bonding portion of a two-ply sheet having two sheets overlapped and bonded together at a bonding portion, and inserts an inner sheet between the two sheets of the two-ply sheet separated to form an enclosed two-ply sheet. The lamination processing device includes a power cord and bonds the two sheets of the enclosed two-ply sheet. The sheet separator has a feeding port from which the two sheets and the inner sheet are fed and disposed on one of side faces of the sheet separator, and a feeding area in the vicinity of the feeding port. The lamination processing device has an ejection port from which the enclosed two-ply sheet bonded by the lamination processing device is ejected, and an ejection area in the vicinity of the ejection port. The cord holder holds the power cord to be extended outside the feeding area and the ejection area.

### BRIEF DESCRIPTION OF THE SEVERAL VIEWS OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating an overall configuration of a sheet processing system according to an embodiment of the present disclosure;

FIG. 2A is a side view of a gripper that has moved to a gripping position in a sheet separator illustrated in FIG. 1;

FIG. 2B is a side view of the gripper that has moved to a releasing position in the sheet separator illustrated in FIG. 1;

FIG. 3A is a perspective view of the gripper that has moved to the gripping position in the sheet separator illustrated in FIG. 1;

FIG. 3B is a perspective view of the gripper that has moved to the releasing position in the sheet separator illustrated in FIG. 1;

FIG. 4 is a block diagram illustrating a hardware configuration of the control block of the sheet processing device to control the operation of the sheet processing device;

FIGS. 5A, 5B, 5C, and 5D are schematic views of the sheet separator, each illustrating a sheet separating operation performed in the sheet separator illustrated in FIG. 1;

FIGS. 6A, 6B, 6B′, 6C, 6C′, and 6D are schematic views of the sheet separator, each illustrating the sheet separating operation performed in the sheet separator, subsequent from the sheet separating operation of FIGS. 5A, 5B, 5C, and 5D;

FIGS. 7A, 7B, and 7C are schematic views of the sheet separator, each illustrating the sheet separating operation performed in the sheet separator, subsequent from the sheet separating operation of FIGS. 6A, 6B, 6B′, 6C, 6C′, and 6D;

FIGS. 8A, 8B, and 8C are schematic views of the sheet separator, each illustrating the sheet separating operation performed in the sheet separator, subsequent from the sheet separating operation of FIGS. 7A, 7B, and 7C;

FIGS. 9A, 9B, and 9C are schematic views of the sheet separator, each illustrating the sheet separating operation performed in the sheet separator, subsequent from the sheet separating operation of FIGS. 8A, 8B, and 8C;

FIG. 10 is a schematic view of separation members inserted into a two-ply sheet in a width direction of the two-ply sheet;

FIGS. 11A, 11B, and 11C are perspective views of the separation members, each illustrating the operations of the separation members in the width direction;

FIGS. 12A and 12B are schematic view of a driving mechanism that moves the separation members;

FIG. 13 including FIGS. 13A and 13B is a flowchart illustrating a flow of a control process executed in the sheet processing system;

FIG. 14 is a diagram illustrating the sheet processing system, with two-ply sheets placed on a bypass sheet feeder attached to the sheet processing device;

FIG. 15 is a diagram illustrating the sheet processing system, with the lamination processing device detached from the sheet processing device, according to an embodiment of the present disclosure;

FIG. 16 is a flowchart of control of changing an automatic mode and a manual mode, according to of an embodiment of the present disclosure;

FIG. 17 is a diagram illustrating a display screen of an operation display panel, for selecting an automatic mode or a manual mode, according to an embodiment of the present disclosure;

FIGS. 18A and 18B are diagrams, each illustrating a display screen of an operation display panel, when setting a sheet in an automatic mode, according to an embodiment of the present disclosure;

FIGS. 19A and 19B are diagrams, each illustrating a display screen of an operation display panel, when setting a sheet in a manual mode, according to an embodiment of the present disclosure;

FIGS. 20A and 20B are diagrams, each illustrating a sheet processing system according to Modification 1 of the above-described embodiments of the present disclosure;

FIG. 21 is a diagram illustrating a sheet processing system according to Modification 2 of the above-described embodiments of the present disclosure;

FIG. 22 is a diagram illustrating a sheet processing system, with a jammed two-ply sheet removed from the sheet processing system of FIG. 21;

FIG. 23A is a diagram illustrating a sheet processing system in an automatic mode, according to Modification 3 of the above-described embodiments of the present disclosure;

FIG. 23B is a diagram illustrating a sheet processing system in a manual mode, according to Modification 3 of the above-described embodiments of the present disclosure;

FIG. 24 is a schematic perspective view of the sheet processing system of FIG. 23, with a part of a relay conveyor rotated to form a bypass sheet feeder; FIG. 25 is a top view of a sheet processing system according to Modification 4 of the above-described embodiments of the present disclosure;

FIG. 26 is a schematic perspective view of a sheet processing system according to an embodiment of the present disclosure;

FIG. 27 is a schematic perspective view of the sheet processing system of FIG. 26, when a lamination processing device is attached to a sheet processing device;

FIG. 28 is a schematic top view of a sheet processing system according to an embodiment of the present disclosure;

FIG. 29A is a schematic perspective view of a sheet processing system as a comparative example illustrating a lamination processing device being attached to a sheet processing device;

FIG. 29B is a schematic perspective view of the sheet processing system as a comparative example illustrating the lamination processing device attached to the sheet processing device;

FIG. 30 is a schematic perspective view of a sheet processing system according to Modification 5 of an embodiment of the present disclosure;

FIG. 31 is a schematic top view of the sheet processing system of FIG. 30;

FIG. 32 is a schematic perspective view of a sheet processing system according to Modification 6 of an embodiment of the present disclosure;

FIGS. 33A and 33B are cross-sectional views, each illustrating an area including a first cord holder of the sheet processing system of FIG. 32;

FIG. 34 is a schematic perspective view of a sheet processing system according to Modification 7 of an embodiment of the present disclosure;

FIGS. 35A and 35B are top views, each illustrating an area including cord winding portions of the sheet processing system of FIG. 34; and

FIGS. 36A and 36B are top views, each illustrating the cord winding portions, according to another embodiment of the present disclosure.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

It will be understood that if an element or layer is referred to as being “on,” “against,” “connected to” or “coupled to” another element or layer, then it can be directly on, against, connected or coupled to the other element or layer, or intervening elements or layers may be present. In contrast, if an element is referred to as being “directly on,” “directly connected to” or “directly coupled to” another element or layer, then there are no intervening elements or layers present. As used herein, the term “connected/coupled” includes both direct connections and connections in which there are one or more intermediate connecting elements. Like numbers refer to like elements throughout. As used herein, the term “and/or” includes any and all combinations of one or more of the associated listed items.

Spatially relative terms, such as “beneath,” “below,” “lower,” “above,” “upper” and the like may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements describes as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors herein interpreted accordingly.

The terminology used herein is for describing particular embodiments and examples and is not intended to be limiting of exemplary embodiments of this disclosure. As used herein, the singular forms “a,” “an,” and “the” are intended to include the plural forms as well, unless the context clearly indicates otherwise. It will be further understood that the terms “includes” and/or “including,” when used in this specification, specify the presence of stated features, integers, steps, operations, elements, and/or components, but do not preclude the presence or addition of one or more other features, integers, steps, operations, elements, components, and/or groups thereof.

Referring now to the drawings, embodiments of the present disclosure are described below. As used herein, the singular forms “a,” “an,” and “the” are intended to include the plural forms as well, unless the context clearly indicates otherwise.

Before describing embodiments of the present disclosure, preliminary matters for facilitating understanding of the embodiments will be described below.

Embodiments of the present disclosure are described below in detail with reference to the drawings. In the drawings, the same or corresponding parts are denoted by the same reference numerals, and redundant description thereof are simplified or omitted as appropriate.

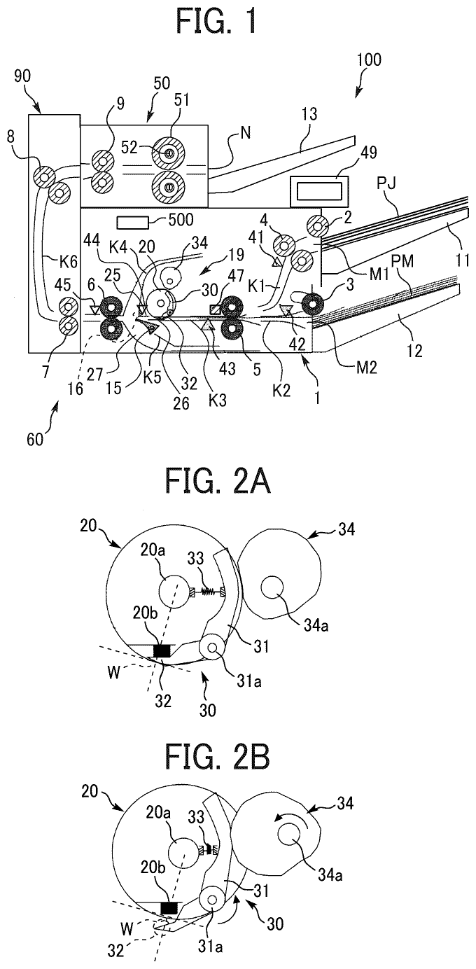

Initially with reference to FIG. 1, a description is given of the overall configuration and operations of a sheet processing system.

FIG. 1 is a diagram illustrating an overall configuration of a sheet processing system 100 according to an embodiment of the present disclosure.

The sheet processing system 100 includes a sheet processing device 60 and a lamination processing device 50. The sheet processing device 60 includes a sheet separator 1 and a relay conveyor 90.

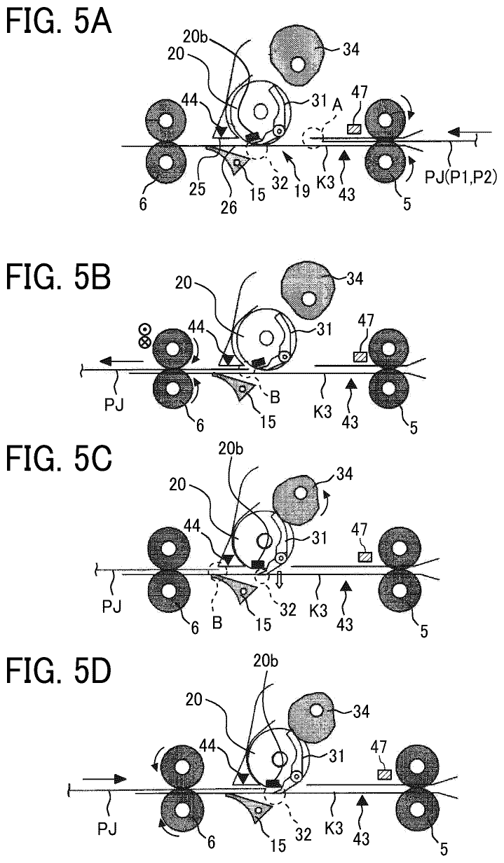

The sheet separator 1 includes a sheet separation assembly 19 that separates the non-bonding portion of a two-ply sheet PJ in which two sheets, which are a first sheet P1 and a second sheet P2, are overlapped and bonded together at a bonding portion A of the two-ply sheet PJ (see FIG. 5A). The sheet separation assembly 19 performs the sheet separating operation and the sheet inserting operation. To be more specific, the sheet separation assembly 19 performs the sheet separating operation to separate the non-bonding portion of the two-ply sheet PJ. The sheet separation assembly 19 then performs the sheet inserting operation to insert the inner sheet PM into the two-ply sheet PJ between the first sheet P1 and the second sheet P2 separated from each other in the sheet separating operation.

The lamination processing device 50 performs a sheet laminating operation on the two-ply sheet PJ with the inner sheet PM enclosed between the first sheet P1 and the second sheet P2 that are separated by the sheet separator 1. The two-ply PJ with the inner sheet PM enclosed between the first sheet P1 and the second sheet P2 may be referred to as an “enclosed two-ply sheet.” In the present embodiment, the lamination processing device 50 is disposed above the sheet separator 1 and downstream from the sheet separator 1 in the sheet conveyance direction.

The relay conveyor 90 conveys the enclosed two-ply sheet, which is the two-ply sheet PJ with the inner sheet PM enclosed between the first sheet P1 and the second sheet P2, from the sheet separator 1 toward the lamination processing device 50. In the present embodiment, the relay conveyor 90 is disposed on the same side of the sheet separator 1 and the lamination processing device 50.

On the exterior of the sheet processing device 60, an operation display panel 49 (in other words, an operation display) on which various kinds of information of the sheet processing system 100 are displayed or to which various kinds of commands are input.

In particular, in the present embodiment, the two-ply sheet PJ includes the first sheet P1 and the second sheet P2 overlapped and bonded together at one sides of the four sides as the bonding portion A. In other words, in the two-ply sheet PJ including the first sheet P1 and the second sheet P2, one side (the bonding portion A) of the first sheet P1 and one side (the bonding portion A) of the second sheet P2 are bonded (attached) by, e.g., thermal welding, and the other side of the first sheet P1 and the other side of the second sheet P2 are not bonded (attached). As the first sheet P1 and the second sheet P2 of the two-ply sheet PJ, a transparent film sheet (that is, a lamination sheet) may be employed.

The two-ply sheet PJ may be made by folding a single sheet. In the present disclosure, the two-ply sheet PJ made by folding a single sheet is also defined as the two sheets overlapped, a folded portion of the folded single sheet is defined as the “bonding portion”, and the other portions are defined as the “non-bonding portion” or the “non-bonding portions”.

The sheet separation assembly 19 separates the non-bonding portion of the two sheets (the first sheet P1 and the second sheet P2) of the two-ply sheet PJ between a winding roller 20 and the third conveyance roller pair 6 (in other words, separates the two sheets, which are the first sheet P1 and the second sheet P2, of the two-ply sheet PJ around the bonding portion A that maintains bonding of the first sheet P1 and the second sheet P2). Subsequently, the sheet separation assembly 19 performs an operation in which the inner sheet PM is inserted between the separated two sheets, which are the first sheet P1 and the second sheet P2 of the two-ply sheet PJ. The inner sheet PM is a sheet such as one plain sheet.

As illustrated in FIG. 1, the sheet separator 1 includes the sheet separation assembly 19, a first sheet tray 11, a second sheet tray 12, a first feed roller 2, a second feed roller 3, a first conveyance roller pair 4, a second conveyance roller pair 5, a third conveyance roller pair 6, an ejection tray 13, a first sensor 41, a second sensor 42, a third sensor 43, a fourth sensor 44, a fifth sensor 45, a displacement detector 47, a first guide 25 serving as an inner restriction member, a second guide 26 serving as an outer restriction member, and a third guide 27.

The sheet separation assembly 19 further includes the winding roller 20, a moving mechanism 30, switching members 15, and separation members 16.

The sheet separator 1 further includes multiple sheet conveyance passages such as a first sheet conveyance passage K1 (curved conveyance passage), a second sheet conveyance passage K2, a third sheet conveyance passage K3, a first branched sheet conveyance passage K4, and a second branched sheet conveyance passage K5. Each of the first sheet conveyance passage K1, the second sheet conveyance passage K2, the third sheet conveyance passage K3, the first branched sheet conveyance passage K4, and the second branched sheet conveyance passage K5 includes two conveyance guides (guide plates) facing each other to guide and convey the sheet such as the two-ply sheet PJ or the inner sheet PM.

To be more specific, two-ply sheets PJ are stacked on the first sheet tray 11. The first feed roller 2 feeds the uppermost two-ply sheet PJ that is placed on top of the two-ply sheets PJ on the first sheet tray 11, to the first conveyance roller pair 4, and the first conveyance roller pair 4 conveys the (uppermost) two-ply sheet PJ along the first sheet conveyance passage K1.

Further, inner sheets PM are stacked on the second sheet tray 12. Then, the second feed roller 3 feeds the uppermost inner sheet PM placed on top of the inner sheets PM on the second sheet tray 12.

Each of the first conveyance roller pair 4, the second conveyance roller pair 5, and the third conveyance roller pair 6 includes a drive roller and a driven roller each having an elastic layer made of, for example, rubber formed on a core, and conveys the sheet nipped by the respective nip regions formed by the drive roller and the driven roller. The third sheet conveyance passage K3 is a passage from the second conveyance roller pair 5 to the third conveyance roller pair 6 and provided with the second conveyance roller pair 5, the winding roller 20, and the third conveyance roller pair 6 in this order from upstream to downstream in the sheet conveyance direction. In particular, the third conveyance roller pair 6 is rotatable in forward to convey the sheet in the forward direction or in reverse to convey the sheet in the reverse direction. The third conveyance roller pair 6 also functions as an ejection roller pair that ejects the sheet to the relay conveyor 90. Further, the third conveyance roller pair 6 is a conveyance roller pair that nips and conveys a two-ply sheet PJ in the sheet separating operation. The third conveyance roller pair 6 moves in a direction opposite to the direction in which the third conveyance roller pair 6 displaced while nipping the two-ply sheet PJ (the width direction of the two-ply sheet PJ) in order to cancel a displacement volume α (lateral registration) of the two-ply sheet PJ detected by the displacement detector 47. The third conveyance roller pair 6 also serves as a lateral registration adjuster to adjust the displacement volume α of a two-ply sheet PJ.

Each of the first sensor 41, the second sensor 42, the third sensor 43, the fourth sensor 44, and the fifth sensor 45 functions as a sheet sensor employing a reflective photosensor that optically detects whether the sheet is present at the position of each sensor. The first sensor 41 is disposed at a position near the portion downstream from the first conveyance roller pair 4 in the sheet conveyance direction. The second sensor 42 is disposed at the position near a portion downstream from the second feed roller 3 in the sheet conveyance direction. The third sensor 43 is disposed at the position between the second conveyance roller pair 5 and the winding roller 20 and near a portion downstream from the second conveyance roller pair 5 in the sheet conveyance direction. The fourth sensor 44 serving as a sheet detection sensor is disposed at the position near a portion downstream from the winding roller 20 and upstream from the third conveyance roller pair 6 in the sheet conveyance direction. The fifth sensor 45 is disposed at the position downstream from the third conveyance roller pair 6 in the sheet conveyance direction.

The displacement detector 47 is disposed near the third sensor 43. The displacement detector 47 detects the displacement volume in the width direction (i.e., the direction orthogonal to the drawing sheet of FIG. 1) of the two-ply sheet PJ or the inner sheet PM to be conveyed toward the sheet separation assembly 19.

A description is given of the winding roller 20 with reference to FIGS. 2A, 2B, 3A, 3B, 6B, 6B′, 6C, 6C′, 6D, and 7A.

FIG. 2A is a side view of a gripper 32 that has moved to a gripping position in the sheet separator 1 illustrated in FIG. 1.

FIG. 2B is a side view of the gripper 32 that has moved to a releasing position in the sheet separator 1 illustrated in FIG. 1.

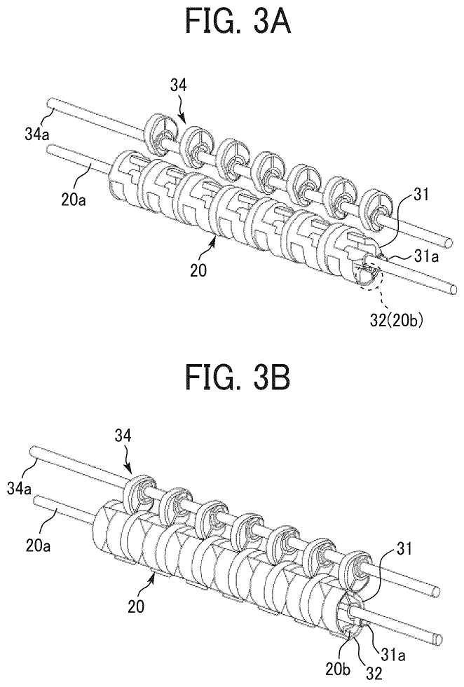

FIG. 3A is a perspective view of the gripper 32 that has moved to the gripping position in the sheet separator 1 illustrated in FIG. 1.

FIG. 3B is a perspective view of the gripper 32 that has moved to the releasing position in the sheet separator 1 illustrated in FIG. 1.

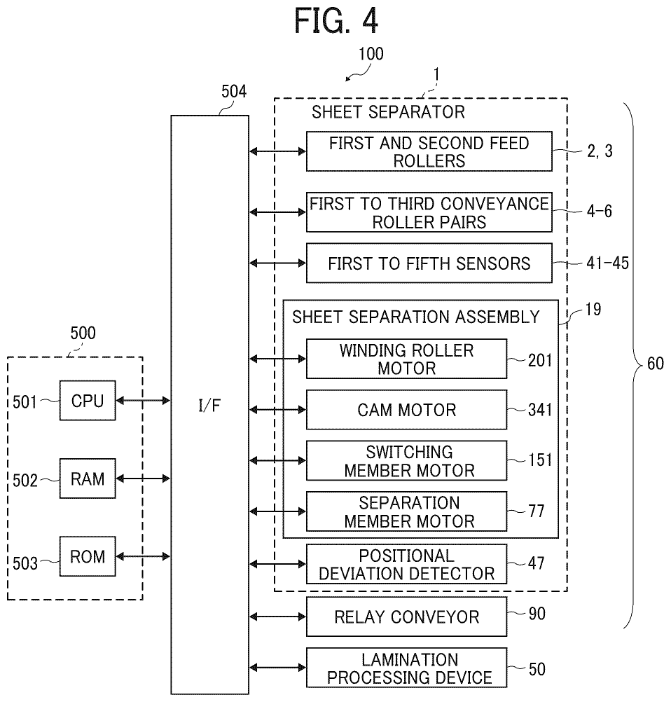

FIG. 4 is a block diagram illustrating a hardware configuration of the control block of the sheet processing device to control the operation of the sheet processing device 60.

FIGS. 5A, 5B, 5C, and 5D are schematic views of the sheet separator 1, each illustrating a sheet separating operation performed in the sheet separator 1 illustrated in FIG. 1.

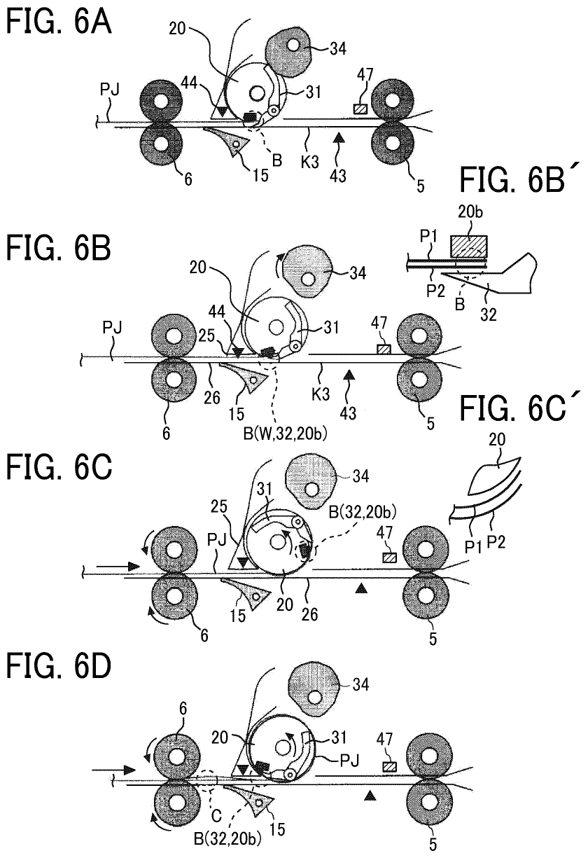

FIGS. 6A, 6B, 6B′, 6C, 6C′, and 6D are schematic views of the sheet separator 1, each illustrating the sheet separating operation performed in the sheet separator 1, subsequent from the sheet separating operation of FIGS. 5A, 5B, 5C, and 5D.

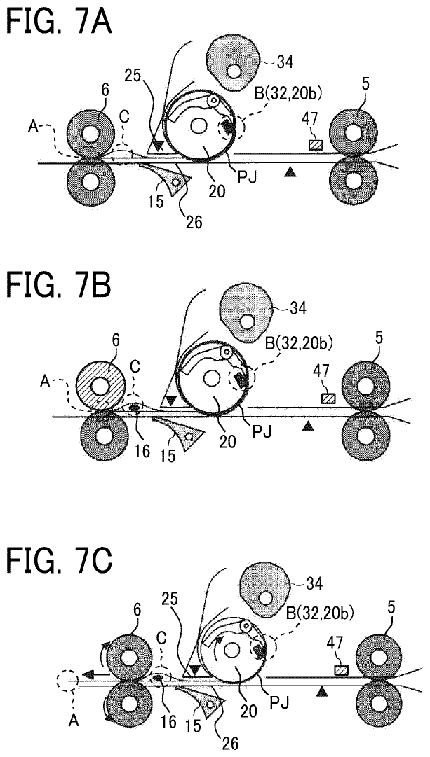

FIGS. 7A, 7B, and 7C are schematic views of the sheet separator 1, each illustrating the sheet separating operation performed in the sheet separator 1, subsequent from the sheet separating operation of FIGS. 6A, 6B, 6B′, 6C, 6C′, and 6D.

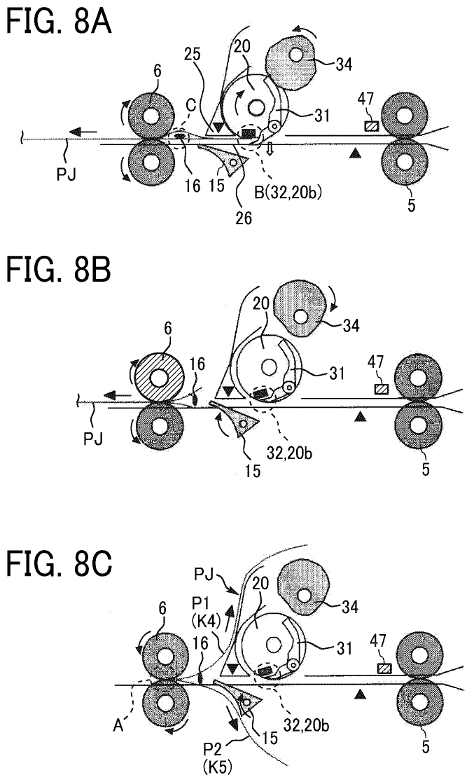

FIGS. 8A, 8B, and 8C are schematic views of the sheet separator 1, each illustrating the sheet separating operation performed in the sheet separator 1, subsequent from the sheet separating operation of FIGS. 7A, 7B, and 7C.

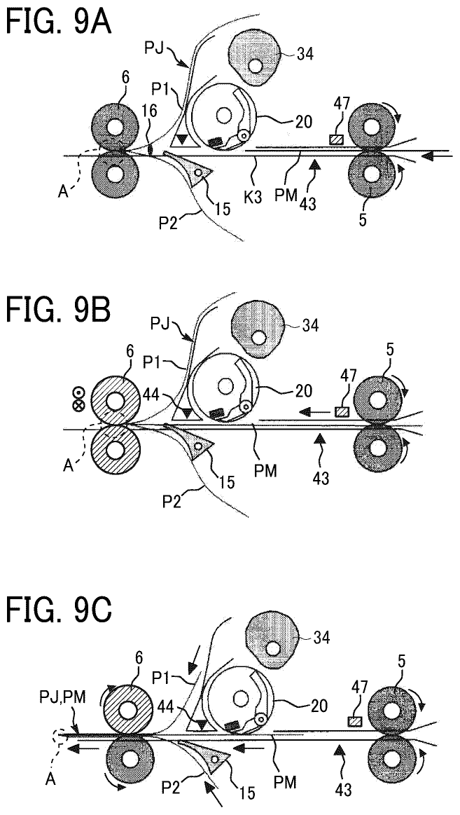

FIGS. 9A, 9B, and 9C are schematic views of the sheet separator 1, each illustrating the sheet separating operation performed in the sheet separator 1, subsequent from the sheet separating operation of FIGS. 8A, 8B, and 8C.

The winding roller 20 is a roller that rotates in a predetermined rotational direction to wind the two-ply sheet PJ around the winding roller 20 while the gripper 32 that functions as a handle gripping a gripped portion B of the two-ply sheet PJ at a winding start position W. The gripped portion B is an end of the two-ply sheet PJ that is the other end to the end at which the bonding portion A is formed, which is referred to as the other end of the two-ply sheet PJ. The winding roller 20 is rotatable around a rotary shaft 20a in the forward direction and in the reverse direction. The controller 500 controls a winding roller motor 201 (see FIG. 4) that drives the winding roller 20.

More specifically, as illustrated in FIG. 1, the two-ply sheet PJ starts from the first sheet tray 11 and passes through the first sheet conveyance passage K1, and the second conveyance roller pair 5 conveys the two-ply sheet PJ in the forward direction along the third sheet conveyance passage K3. The two-ply sheet PJ temporarily passes through the position of the winding roller 20, and then is conveyed to the position of the third conveyance roller pair 6.

Then, the third conveyance roller pair 6 as a conveyance roller pair rotates in the reverse direction to convey the two-ply sheet PJ in the reverse direction to the position of the winding roller 20, and the gripper 32 grips the other end (leading end) of the two-ply sheet PJ. The two-ply sheet PJ is further conveyed while the other end (leading end) of the two-ply sheet PJ is gripped by the gripper 32, and the winding roller 20 rotates in the counterclockwise direction in FIG. 1 to wind the two-ply sheet PJ around the winding roller 20.

With reference to FIG. 6C′, as the winding roller 20 winds the two-ply sheet PJ, the linear velocity of the sheet P1 is proportional to the distance to the sheet P1 from the center of the winding roller 20 and the linear velocity of the sheet P2 is proportional to the distance to the sheet P2 from the center of the winding roller 20, so that the linear velocity of the surface of the winding roller 20 is proportional to the radius of the winding roller 20. Due to such a configuration, the sheet P1 is closer to the center of the winding roller 20 than the sheet P2, in other words, the sheet P1 is positioned at an inner side to the center of the winding roller 20 than the sheet P2, so that the linear velocity of the sheet P1 is lower than the linear velocity of the sheet P2.

As a result, the sheet P1 that is conveyed before the sheet P2 is more likely to slacken than the sheet P2. As illustrated in FIGS. 6D and 7A, a gap C is formed between the first sheet P1 and the second sheet P2 at the bonding portion A (the other end) of the two-ply sheet PJ, in other words, the gap C is formed as the first sheet P1 located upper than the second sheet P2 warps upward.

As described above, the first sheet P1 and the second sheet P2 that are in close contact with each other without any gap are separated (peeled) from each other.

A description is further given of a mechanism that generates the gap C in the two-ply sheet PJ between the winding roller 20 and the third conveyance roller pair 6 by winding the two-ply sheet PJ around the winding roller 20.

The two-ply sheet PJ wound around the winding roller 20 is gripped by the gripper 32, restricting displacement in the two-ply sheet PJ. Due to this configuration, a slip is generated between the first sheet P1 and the second sheet P2 by the amount of difference in the circumferential length of the winding roller 20. Due to the slip, the conveyance amount of the inner sheet (i.e., the first sheet P1) is smaller than the conveyance amount of the outer sheet (i.e., the second sheet P2). As a result, slack is generated in the inner sheet (i.e., the first sheet P1) between the nip region of the third conveyance roller pair 6 and the winding roller 20.

At this time, as the two-ply sheet PJ is wound around the winding roller 20 by one or more rounds, the difference in the winding circumferential length is generated between the inner circumference and the outer circumference by the thickness of the sheet. As a result, the slack is additionally generated.

Finally, the slack is collected between the third conveyance roller pair 6 and the winding roller 20, and the gap C is formed between the two sheets P1 and P2.

More specifically, a distance from the rotary shaft 20a (i.e., the axial center) of the winding roller 20 to the second sheet P2 on the outer side of the winding roller 20 is R+ΔR, where a distance from the rotary shaft 20a (i.e., the axial center) of the winding roller 20 to the first sheet P1 on the inner side of the winding roller 20 is “R” and the thickness of the first sheet P1 on the inner side of the winding roller 20 is “ΔR”. Since the radius of the first sheet P1 wound around the inner side of the winding roller 20 and the radius of the second sheet P2 wound around the outer side of the first sheet P1 are different by the thickness ΔR of the first sheet P1 (wound around the inner side of the winding roller 20), a circumferential length difference of 2×ΔR×π is generated between the inner sheet (i.e., the first sheet P1) and the outer sheet (i.e., the second sheet P2) when the two-ply sheet PJ is wound around the winding roller 20 by one round. As a result, where the number of winding the two-ply sheet PJ around the winding roller 20 is M times, the slack of the inner sheet (i.e., the first sheet P1) is generated by the circumferential length difference of 2×ΔR×π×M.

Finally, the slack is accumulated between the third conveyance roller pair 6 and the winding roller 20, and the gap C corresponding to the circumferential length difference of 2×ΔR×π×M is formed between the first sheet P1 and the second sheet P2.

Particularly in the present embodiment, in order to significantly form the gap C as described above, the two-ply sheet PJ is wound around the winding roller 20 at least one round.

As described above, in the present embodiment, by providing the winding roller 20 to wind the two-ply sheet PJ around the rotary shaft 20a, the two-ply sheet PJ can be separated without increasing the size and cost of the sheet separator 1.

As illustrated in FIG. 6B′, the gripper 32 illustrated in FIG. 2A in the present embodiment grips the gripped portion B of the two-ply sheet PJ without contacting the leading end face of the one end of the two-ply sheet PJ (the one end proximate to the gripped portion B).

In the present disclosure, the “end face” of the two-ply sheet is defined as a side face extending in the thickness direction and connecting the front face and the back face of the two-ply sheet. Accordingly, there are four end faces of the rectangular two-ply sheet on the front, back, left, and right.

More specifically, the gripper 32 nips and grips the gripped portion B of the two-ply sheet PJ in a direction orthogonal to the sheet surface of the gripped portion B of the two-ply sheet PJ between the gripper 32 and a receiving portion 20b of the winding roller 20 without restricting the end face of the one end of the two-ply sheet PJ from hitting any member, in other words, without causing any member to contact the end face of the two-ply sheet PJ. The receiving portion 20b of the winding roller 20 is a part of the outer circumferential portion of the winding roller 20 and can be arranged to face the gripper 32. More specifically, the receiving portion 20b is in a portion recessed inward from a virtual outer circumferential face of the winding roller 20. The virtual outer circumferential face is an outer circumferential face having a circular shape around which the two-ply sheet PJ is wound.

More specifically, the two-ply sheet PJ is not nipped and gripped by the gripper 32 and the receiving portion 20b of the winding roller 20 by being restricted while a specified member such as the gripper 32 contacts the end face of the one end (that is the leading end face). The two-ply sheet PJ is nipped and gripped by the gripper 32 and the receiving portion 20b while the end face of the one end (leading end face) does not contact any member.

Accordingly, the gripped portion B of the one end (leading end face) of the two-ply sheet PJ is gripped by the gripper 32 and the receiving portion 20b of the winding roller 20, and the end face (leading end face) of the one end of the two-ply sheet PJ does not contact an obtuse angle portion (wedge portion) of the gripper 32 in FIG. 6B′.

Without contacting any member, the end face (leading end) of the one end of the two-ply sheet PJ coincides with an end of a contact face of the receiving portion 20b at which the gripper 32 contacts the receiving portion 20b via the two-ply sheet PJ (the right end of the contact face in FIG. 6B′).

The end face (leading end) of the one end of the two-ply sheet PJ may move to the right end of the contact face in FIG. 6B′ avoiding the contact face between the gripper 32 and the receiving portion 20b so that the gripped portion B is inside the sheet from the leading end of the one end (the gripped portion B is in the portion proximate to the other end from the leading end of the one end) of the two-ply sheet PJ. Alternatively, the end face (leading end face) of the one end of the two-ply sheet PJ may be within the contact face between the gripper 32 and the receiving portion 20b of the winding roller 20 in FIG. 6B′.

Accordingly, when compared with a configuration in which the leading end face of the two-ply sheet PJ contacts a member, the above-described structure according to the present embodiment can reduce damage on the two-ply sheet PJ (particularly, the leading end).

In the present embodiment, the two-ply sheet PJ wound around the winding roller 20 has the bonding portion A at the one end of the two-ply sheet PJ and the gripped portion B at the other end of the two-ply sheet PJ.

In the present embodiment, at least the gripper 32 (handle) or the receiving portion 20b is made of elastic material such as rubber, spring, or leaf spring.

According to this configuration, when compared with a known configuration in which the gripper 32 and the receiving portion 20b have rigid bodies made of metal or resin, the above-described configuration according to the present embodiment enhances the gripping force to grip the two-ply sheet PJ and prevents the surfaces of the two-ply sheet PJ from being damaged. In particular, when the gripper 32 and the receiving portion 20b included in the sheet separator 1 are made of the elastic material, the sheet separator 1 can easily achieve the above-described effect.

As illustrated in FIGS. 2A, 2B, 3A, and 3B, the moving mechanism 30 moves the gripper 32 at the winding start position W of the winding roller 20 between a gripping position (position illustrated in FIGS. 2A and 3A) at which the gripper 32 can grip the two-ply sheet PJ and a releasing position (position illustrated in FIGS. 2B and 3B) at which the gripper 32 is released from the gripping position.

Specifically, the moving mechanism 30 includes an arm 31, a compression spring 33, a cam 34, and a motor. The compression spring 33 functions as a biasing member. The motor drives to rotate the cam 34 in the forward direction or the reverse direction.

The arm 31 holds the gripper 32 and is held by the winding roller 20 to be rotatable about a support shaft 31a. In the present embodiment, the gripper 32 is coupled to the base of the arm 31, in other words, the leading end of the arm 31, and the gripper 32 and the arm 31 are integrally made (held) as a single unit. Alternatively, the gripper 32 and the arm 31 may 31 may be made as separate members, and the gripper 32 may be disposed on the arm 31, in other words, may be held by the arm 31. In any case, the arm 31 holding the gripper 32 rotates around the rotary shaft 20a together with the winding roller 20 with the gripper 32.

The compression spring 33 functions as a biasing member that biases the arm 31 so that the gripper 32 moves from the releasing position illustrated in FIG. 2B to the gripping position illustrated in FIG. 2A. More specifically, one end of the compression spring 33 is coupled to a fixed position near the rotary shaft 20a, and the other end of the compression spring 33 is coupled to one end of the arm 31 that is a free end that is in the opposite direction to the other end of the arm 31 coupled to the gripper 32 interposed by the support shaft 31a.

The cam 34 pushes the arm 31 against the biasing force of the compression spring 33 that functions as the biasing member, so that the gripper 32 moves from the gripping position illustrated in FIG. 2A to the releasing position illustrated in FIG. 2B. A motor that is controlled by the controller 500 drives the cam 34 to rotate in the forward direction or the reverse direction at a desired rotation angle. The cam 34 is held by the housing of the lamination processing device 50 so as to be rotatable around a cam shaft 34a separately from the winding roller 20.

In the moving mechanism 30 including the above-described configuration, as illustrated in FIGS. 2A and 3A, when the cam 34 is not in contact with the arm 31, the arm 31 is biased by the compression spring 33 to press the gripper 32 against the receiving portion 20b. This state is referred to as a closed state.

By contrast, as illustrated in FIGS. 2B and 3B, when the cam 34 contacts and presses the arm 31, the arm 31 rotates in the counterclockwise direction in FIG. 2B around the support shaft 31a against the biasing force of the compression spring 33, so that the gripper 32 separates from the receiving portion 20b. This state is referred to as an open state. In the open state, the gripper 32 and the receiving portion 20b cannot grip the two-ply sheet PJ, which is also referred to as a grip release state.

When the gripper 32 is at the releasing position to be in the open state, the two-ply sheet PJ enters a space between the gripper 32 and the receiving portion 20b, and the gripper 32 moves to the gripping position to be in the closed state. As a result, the gripper 32 and the receiving portion 20b grip the two-ply sheet PJ.

In the present embodiment, as illustrated in FIGS. 3A and 3B, the winding roller 20 includes a plurality of roller portions (i.e., seven roller portions in the present embodiment) having a columnar shape and being disposed at given intervals in the axial direction of the winding roller 20. A plurality of grippers 32 and a plurality of arms 31 are disposed at divided positions between adjacent rollers, respectively. The divided positions are recesses between adjacent rollers. A plurality of cams 34 are disposed to be contactable to the plurality of arms 31, respectively.

The two-ply sheet PJ is not gripped at the position over the entire area of the winding roller 20 but is gripped at the divided positions at given intervals in the axial direction of the winding roller 20. By so doing, the load to grip the two-ply sheet PJ can be shared and scratch resistant at the leading end of the two-ply sheet PJ can be reduced. The above-described configuration is useful when a gripping force to grip the two-play sheet PJ increases, for example, when a large or heavy two-ply sheet PJ is gripped.

In the present embodiment, as illustrated in FIG. 1, the third sheet conveyance passage K3 is made of linear conveyance guide plates. By contrast, the third sheet conveyance passage K3 may be made of curved conveyance guide plates. In such a case, a gripping position at which the winding roller 20 grips the two-ply sheet PJ may be changed to be closer to the rotary shaft 20a than the gripping position in the present embodiment. Additionally, in such a case, the position of the gripper 32 according to the present embodiment and the position of the receiving portion 20b according to the present embodiment may be interchanged, so that the gripper 32 may be disposed closer to the rotary shaft 20a than the receiving portion 20b in the winding roller 20.

A description is given of the control system of the sheet processing device 60, with reference to FIG. 4.

As illustrated in FIG. 4, the sheet processing device 60 has a controller 500 including a central processing unit (CPU) 501, a random-access memory (RAM) 502, a read-only memory (ROM) 503, and an interface (I/F) 504. The CPU 501, the RAM 502, are the ROM 503 are connected via the I/F 504.

The CPU 501 is an arithmetic unit and controls the overall operation of the sheet processing system 100.

The RAM 502 is a volatile storage medium that allows data to be read and written at high speed. The CPU 501 uses the RAM 502 as a work area for data processing.

The ROM 503 is a read-only non-volatile storage medium that stores programs such as firmware.

The sheet processing device 60 processes, by an arithmetic function of the CPU 501, e.g., a control program stored in the ROM 503 and an information processing program (or application program) loaded into the RAM 502. Such processing configures a software controller including various functional modules of the sheet processing system 100. The software controller thus configured cooperates with hardware resources of the sheet processing device 60 and the lamination processing device 50 to construct functional blocks to implement functions of the sheet processing system 100. In other words, the CPU 501, the RAM 502, and the ROM 503 constitute the controller 500 (control unit) to control the operations of the sheet processing system 100.

An interface (I/F) 504 is an interface that connects the sheet separator 1 and the relay conveyor 90, both included in the sheet processing device 60, and various drive members and various sensors included in the lamination processing device 50, to the controller 500. The controller 500 drives the sheet separator 1 and the relay conveyor 90 of the sheet processing device 60, and various drive members included in the lamination processing device 50, via the I/F 504. Further, the controller 500 acquires the detection results from the sheet separator 1 and the relay conveyor 90 of the sheet processing device 60 and various sensors of the lamination processing device 50.

The winding roller motor 201 is a drive unit to drive the winding roller 20.

The cam motor 341 is a drive unit to drive the cam 34. The switching member motor 151 is a drive unit to drive the switching members 15.

A description is given of the fourth sensor 44 provided for the sheet separator 1 according to the present embodiment, with reference to FIGS. 1, 5D, and 6A.

The fourth sensor 44 functions as a sheet detection sensor to detect the two-ply sheet PJ that is conveyed toward the winding roller 20. Based on the detection results of the fourth sensor 44 serving as a sheet detection sensor, the controller 500 controls the moving mechanism 30.

More specifically, the fourth sensor 44 is disposed on the conveyance guide in the sheet conveyance passage between the winding roller 20 and the third conveyance roller pair 6. As illustrated in FIGS. 5D and 6A, when the third conveyance roller pair 6 conveys the two-ply sheet PJ in the reverse direction toward the position of the winding roller 20 in the reverse direction, with the gripped portion B of the two-ply sheet PJ being the leading end, the fourth sensor 44 detects the leading end (i.e., the end of the gripped portion B) of the two-ply sheet PJ. In response to the detection timing at which the fourth sensor 44 detects the leading end (in the reverse direction) of the gripped portion B, the controller 500 adjusts and controls the timing to stop the two-ply sheet PJ at the gripping position and the timing at which the gripper 32 grips the gripped portion B. More specifically, after a given time has elapsed from the detection of the leading end of the two-ply sheet PJ by the fourth sensor 44, the third conveyance roller pair 6 stops conveyance of the two-ply sheet PJ in the reverse direction, and the cam 34 rotates to pivot the arm 31 of the moving mechanism 30 so that the gripper 32 moves from the releasing position illustrated in FIG. 2B to the gripping position illustrated in FIG. 2A.

The above-described control accurately performs an operation in which the end face of the two-ply sheet PJ is nipped by the gripper 32 and the receiving portion 20b without contacting the end face of the two-ply sheet PJ on any member.

As described above, the third conveyance roller pair 6 is a sheet conveyance roller pair that conveys the two-ply sheet PJ with the one end (i.e., the gripped portion B) as a leading end, toward the winding start position W of the winding roller 20 in the third sheet conveyance passage K3 (sheet conveyance passage) between the third conveyance roller pair 6 and the winding roller 20.

A description is given of the separation members 16 with reference to FIGS. 7A, 7B, 7C, 10, 11A, 11B, and 11C.

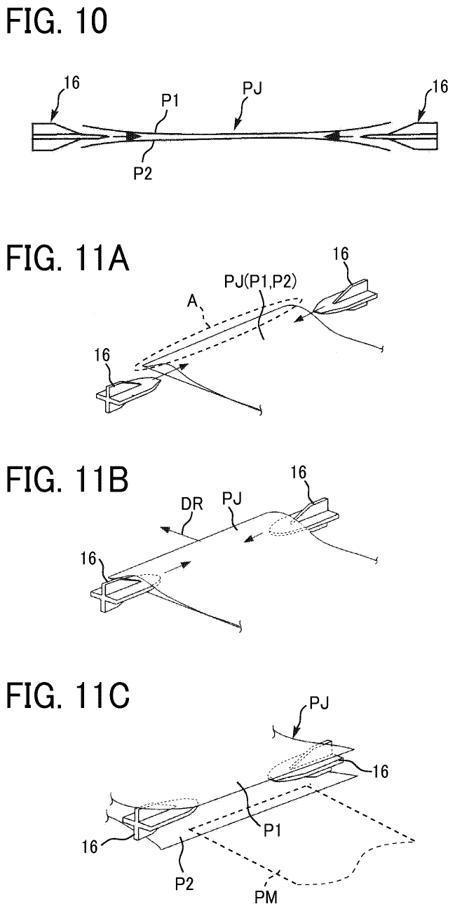

FIG. 10 is a schematic view of the separation members 16 inserted into the two-ply sheet PJ in the width direction of the two-ply sheet PJ.

FIGS. 11A, 11B, and 11C are perspective views of the separation members 16, each illustrating the operations of the separation members 16 in the width direction of the two-ply sheet PJ.

The separation members 16 are inserted into the gap C formed between the first sheet P1 and the second sheet P2 at a position between the winding roller 20 and the third conveyance roller pair 6 from the outside of both ends of the two-ply sheet PJ in the width direction of the two-ply sheet PJ, with respect to the two-ply sheet PJ when the one end (that is the gripped portion B) is wound by the winding roller 20 and the other end (that is the bonding portion A) is nipped by the third conveyance roller pair 6 (sheet conveyance roller pair).

More specifically, in the present embodiment, the separation members 16 are disposed at both ends of the two-ply sheet PJ in the width direction that is the direction perpendicular to a plane on which FIGS. 7A, 7B, and 7C are illustrated and the horizontal direction in FIG. 10. The separation members 16 are separation plates, more specifically, the separation members 16 have respective fins extending in the vertical direction from respective plates. In the direction in which the separation members 16 are inserted into the two-ply sheet PJ, each of the respective plates has the rear end and the front end at the center in the width direction of the plates. The plate thickness and the plate width of each of the respective plates gradually increase from the front end to the rear end of the fin. The vertical length (length in the vertical direction) of the fin gradually increases from the front end of the fin in the direction in which the separation member 16 is inserted into the two-ply sheet PJ. The fin and the plate in each of the separation members 16 form a cross shape at the rear end of the fin (see FIG. 11A). Further, the separation members 16 are movable in the width direction of the two-ply sheet PJ by a moving device controlled by the controller 500 so as not to contact with each other.

The separation members 16 having the above-described configuration stand by at respective standby positions (see FIG. 11A) at which the separation members 16 do not interfere with conveyance of the sheet such as the two-ply sheet PJ in the third sheet conveyance passage K3 until the gap C is formed between the two sheets (the first sheet P1 and the second sheet P2) as illustrated in FIG. 7A. Subsequently, as illustrated in FIGS. 10 and 11B, the separation members 16 enter the gap C in the two-ply sheet PJ when separating the two-ply sheet PJ (including the first sheet P1 and the second sheet P2). As a result, the separation members 16 give the gap C to be relatively large.

The moving device that moves the separation members 16 in the width direction of the two-ply sheet PJ may employ, for example, a rack and pinion mechanism.

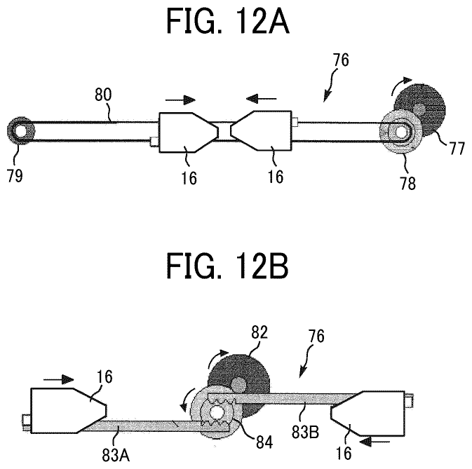

More specifically, the moving device that moves the pair of separation members 16 in the width direction may employ a driving mechanism 76 as illustrated in FIG. 12A or FIG. 12B.

FIGS. 12A and 12B are schematic view of the driving mechanism 76 to move the separation members 16.

In the present embodiment, the two separation members 16 are disposed facing each other, as illustrated in FIGS. 12A and 12B. The driving mechanism 76 illustrated in FIG. 12A moves the two separation members 16 by a belt driving. On the other hand, the driving mechanism 76 illustrated in FIG. 12B moves the two separation members 16 by a rack and pinion driving.

More specifically, the driving mechanism 76 illustrated in FIG. 12A includes a belt 80 stretched between a drive pulley 78 and a driven pulley 79 and the two separation members 16 are attached to the belt 80 while facing each other. Of the two separation members 16, one separation member 16 is attached and connected to the lower part of the belt 80 and the other separation member 16 is attached and connected to the upper part of the belt 80. The drive pulley 78 includes a drive gear that meshes with a motor gear mounted on the motor shaft of the separation member motor 77. The rotation output of the separation member motor 77 is transmitted to the belt 80. More specifically, as the motor gear of the separation member motor 77 rotates in the clockwise direction in FIG. 12A, the two separation members 16 approach toward each other. On the other hand, as the motor gear of the separation member motor 77 rotates in the counterclockwise direction in FIG. 12A, the two separation members 16 move away from each other.

The driving mechanism 76 illustrated in FIG. 12B includes two racks 83A and 83B extending in opposite directions from each other. Each of the racks 83A and 83B meshes with a single pinion 84. One separation member 16 that is attached to the rack 83A faces the other separation member 16 that is attached to the rack 83B. The pinion 84 includes a drive gear that meshes with a motor gear mounted on the motor shaft of a drive motor 82. The rotational output of the drive motor 82 is transmitted to the racks 83A and 83B. More specifically, as the motor gear of the drive motor 82 rotates in the clockwise direction in FIG. 12B, the two separation members 16 approach toward each other. On the other hand, as the motor gear of the separation member motor 77 rotates in the counterclockwise direction in FIG. 12B, the two separation members 16 move away from each other.

As described above, each of the separation members 16 of the present embodiment has the above-described shape having the plate and the fin extending in the vertical direction and is movable in the width direction of the two-ply sheet PJ due to the driving by the driving mechanism 76. Due to such a configuration, the separation members 16 are smoothly inserted into the gap C generated in the two-ply sheet PJ as illustrated in FIG. 11B.

A description is given of the switching members 15, with reference to FIGS. 8A, 8B, and 8C.

As described above, FIGS. 8A, 8B, and 8C are schematic views of the sheet separator 1, each illustrating the sheet separating operation performed in the sheet separator 1, subsequent from the sheet separating operation of FIGS. 7A, 7B, and 7C and FIGS. 9A, 9B, and 9C are schematic views of the sheet separator 1, each illustrating the sheet separating operation performed in the sheet separator 1, subsequent from the sheet separating operation of FIGS. 8A, 8B, and 8C.

As illustrated in FIGS. 8A, 8B, and 8C, the switching members 15 are switching plates disposed between the separation members 16 and the winding roller 20. Note that the switching members 15 may also be referred to in a singular form as “switching member 15” for convenience. The two-ply sheet PJ is separated into the two sheets, which are the first sheet P1 and the second sheet P2, by the separation members 16, and the two sheets P1 and P2 of the two-ply sheet PJ having stiffness are guided to respective directions different from each other, specifically, to the first branched sheet conveyance passage K4 and the second branched sheet conveyance passage K5, respectively. The first branched sheet conveyance passage K4 and the second branched sheet conveyance passage K5 are branched from the third sheet conveyance passage K3 (sheet conveyance passage) interposed by the third sheet conveyance passage K3. The switching member 15 is a claw-shaped moving member to rotate in forward or in reverse within a range of a predetermined angle to guide the two-ply sheet PJ.

More specifically, in the present embodiment, the switching members 15 are spaced apart from each other in the width direction of the two-ply sheet PJ, in other words, in the direction perpendicular to a plane of the drawing sheets on which FIGS. 8A, 8B, and 8C are illustrated. Further, the switching members 15 are rotatable around the support shaft by the switching member motor 151 (see FIG. 4) that is controlled by the controller 500.

The switching members 15 having the above-described configuration stand by at respective standby positions (see FIG. 8A) at which the switching members 15 do not interfere with conveyance of the sheet such as the two-ply sheet PJ in the third sheet conveyance passage K3 until the first sheet P1 and the second sheet P2 of the two-ply sheet PJ separated by the separation members 16 are guided to the first branched sheet conveyance passage K4 and the second branched sheet conveyance passage K5, respectively. When the switching members 15 guide the two sheets P1 and P2 separated from the two-ply sheet PJ by the separation members 16 to the first branched sheet conveyance passage K4 and the second branched sheet conveyance passage K5, respectively, in other words, in the directions different from each other, the switching members 15 rotate to the positions at which the switching members 15 prevent the two-ply sheet PJ from entering the third sheet conveyance passage K3 when viewed from the two-ply sheet PJ as illustrated in FIG. 8B.

As a result, the first sheet P1 is guided to the first branched sheet conveyance passage K4, and the second sheet P2 is guided to the second branched sheet conveyance passage K5.

More specifically, as illustrated in FIG. 8A, after the separation members 16 are inserted into the gap C, the third conveyance roller pair 6 conveys the two-ply sheet PJ to the other end (left side) so that the winding of the one end of the two-ply sheet PJ on the winding roller 20 is released. In other words, the controller 500 causes the third conveyance roller pair 6 to convey the two-ply sheet PJ toward the other end of the two-ply sheet PJ (i.e., the left side in FIG. 8A). After the two-ply sheet PJ has been conveyed as illustrated in FIG. 8B, the third conveyance roller pair 6 conveys the two-ply sheet PJ to the one end (right side) again as illustrated in FIG. 8C. Then, the sheet P1 that is one of the two sheets of the two-ply sheet PJ separated by the separation members 16 is guided to the first branched sheet conveyance passage K4, and the sheet P2 that is the other of the two sheets of the two-ply sheet PJ is guided to the second branched sheet conveyance passage K5. Subsequently, as illustrated in FIGS. 9A, 9B, and 9C, the second conveyance roller pair 5 conveys the inner sheet PM to the other end of the third sheet conveyance passage K3 to insert the inner sheet PM between the first sheet P1 and the second sheet P2 separated from the two-ply sheet PJ.

Referring to FIG. 7A, the first guide 25 is included in the sheet separator 1 according to the present embodiment. The first guide 25 is disposed between the separation members 16 (see FIG. 7B) and the winding roller 20 in the third sheet conveyance passage K3. The first guide 25 functions as an inner restriction member to limit an amount of slack of the first sheet P1 that is wound around the winding roller 20 on the inner side, among the first sheet P1 and the second sheet P2 of the two-ply sheet PJ wound around the winding roller 20.

Further, referring to FIG. 7A, the second guide 26 is included in the sheet separation device 1 according to the present embodiment. The second guide 26 is disposed between the separation members 16 (see FIG. 7B) and the winding roller 20 in the third sheet conveyance passage K3. The second guide 26 functions as an outer restriction member to limit an amount of slack of the second sheet P2 that is wound around the winding roller 20 on the outer side, among the first sheet P1 and the second sheet P2 of the two-ply sheet PJ wound around the winding roller 20, when the second sheet P2 is slackened due to rotational unevenness of the winding roller 20 or the third conveyance roller pair 6.

Referring now to the drawings such as FIG. 1, the lamination processing device 50 includes a thermal pressure roller pair 51 that applies heat and pressure to the two-ply sheet PJ while conveying the two-ply sheet PJ enclosing the inner sheet PM in the forward direction. The thermal pressure roller pair 51 includes a heater 52. The lamination processing device 50 includes a sixth conveyance roller pair 9 serving as a conveyance roller pair to convey the two-ply sheet PJ (enclosing the inner sheet PM) toward the thermal pressure roller pair 51.

After the two-ply sheet PJ has passed through the lamination processing device 50 (the thermal pressure roller pair 51), the entire region of the two-ply sheet PJ is bonded while the inner sheet PM is inserted in the two-ply sheet PJ. Then, the two-ply sheet PJ on which the sheet laminating operation has been performed as described above is ejected to the outside of the lamination processing device 50 to be stacked on the ejection tray 13.

As described above, the sheet processing system 100 according to the present embodiment performs a series of the following operations: an operation to feed the two-ply sheet PJ and the inner sheet PM; an operation to separate the first sheet P1 and the second sheet P2 of the two-ply sheet PJ; an operation to insert the inner sheet PM into the space between the first sheet P1 and the second sheet P2 separated from each other; and an operation to perform the sheet laminating operation on the two-ply sheet PJ enclosing the inner sheet PM. The above-described series of operations can enhance the user convenience for the sheet processing system 100. Such a series of operations is performed as an “automatic mode”, which is described below.

Further, referring to the drawings such as FIG. 1, the relay conveyor 90 includes a relay conveyance passage K6 to convey the two-ply sheet PJ (enclosing the inner sheet PM) sent from the sheet separator 1 toward the lamination processing device 50. The relay conveyance passage K6 is formed by two conveyance guides (guide plates) facing each other and includes the fourth conveyance roller pair 7 and the fifth conveyance roller pair 8.

In the present embodiment, the sixth conveyance roller pair 9 serving as a conveyance roller pair is disposed in the lamination processing device 50. However, the sixth conveyance roller pair 9 may be disposed in the relay conveyor 90.

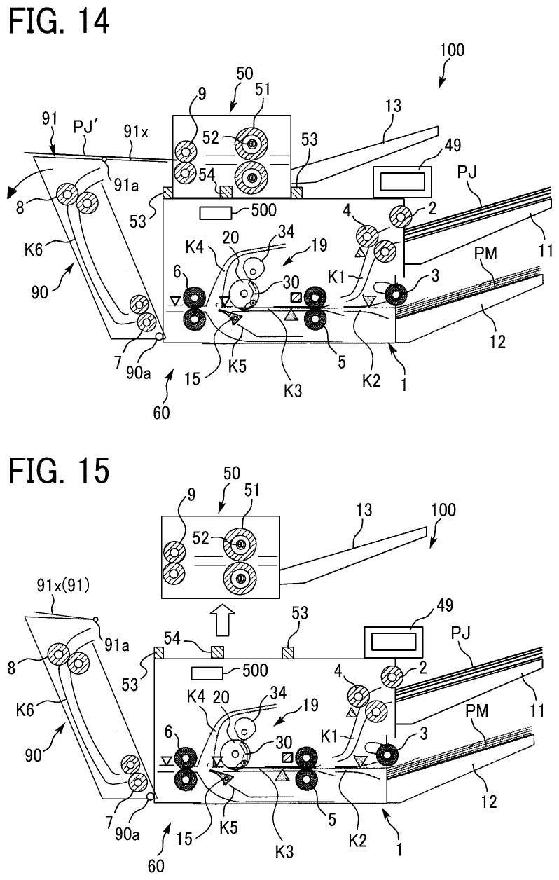

In the present embodiment, the relay conveyor 90 is detachably attached (rotatable) to the sheet separator 1 in the sheet processing device 60. The relay conveyor 90 is detached from the sheet processing system 100 (see FIG. 14) so that bypass conveyance can be performed on a bypass two-ply sheet PJ′ to the lamination processing device 50. Details of this bypass conveyance are described below with reference to the drawings such as FIG. 14.

A description is given of the operations performed in the sheet processing system 100 to the sheet lamination operation is performed by the lamination processing device 50, focusing on the operations performed in the sheet separation assembly 19 of the sheet separator 1 to separate the two-ply sheet PJ, with reference to FIGS. 5 to 9C.

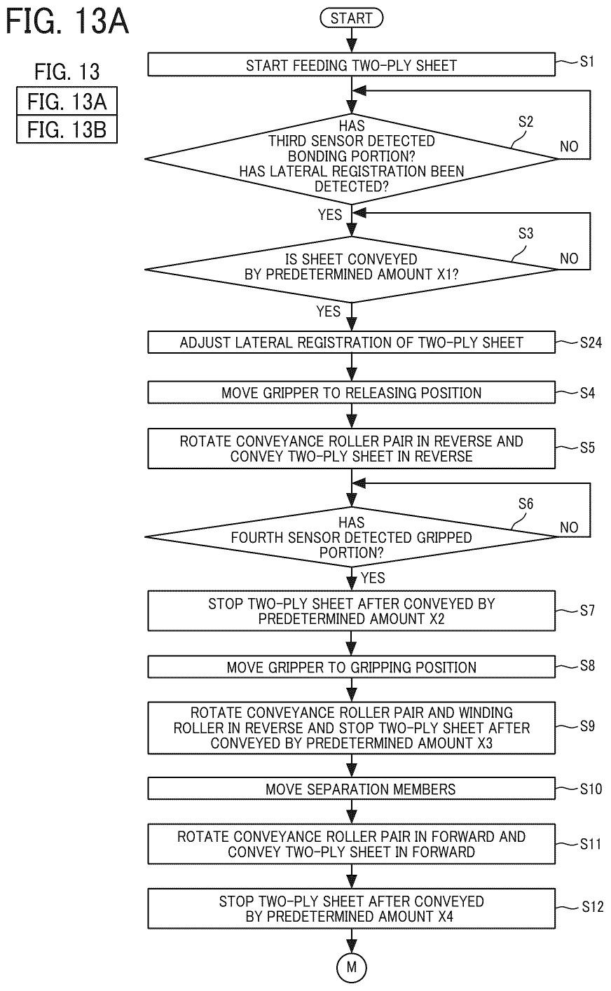

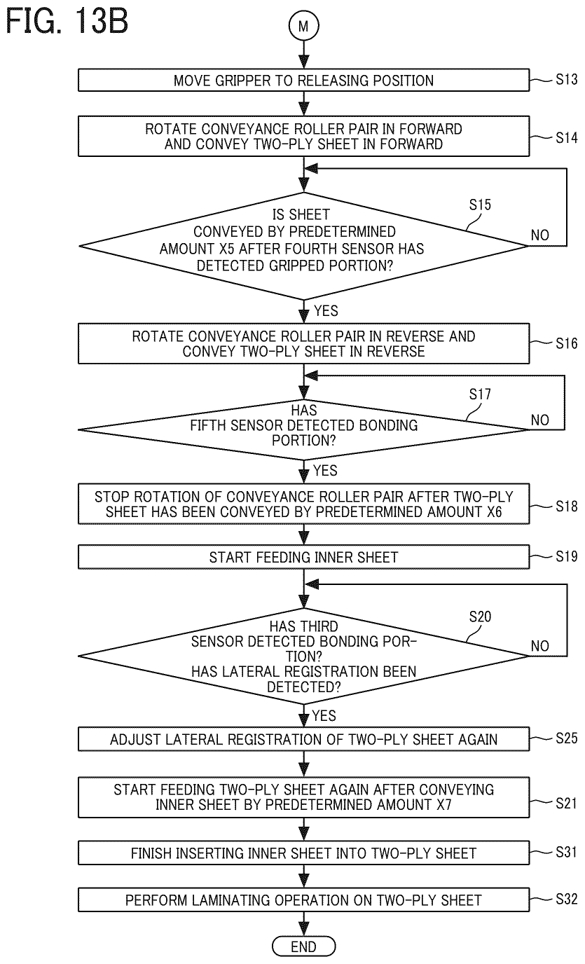

Further, in the description of the operations, the operations of the separation members 16 are appropriately described with reference to FIGS. 10, 11A, 11B, and 11C, and the control flow is described with reference to a flowchart of FIG. 13, that is, FIGS. 13A and 13B.

FIG. 13 including FIGS. 13A and 13B is a flowchart of the control process executed in the sheet separation device 1.

First, the first feed roller 2 and the first conveyance roller pair 5 start feeding the two-ply sheet PJ from the first sheet tray 11 (step S1 of the flowchart in FIG. 13A). Then, as illustrated in FIG. 5A, the second conveyance roller pair 5 conveys the two-ply sheet PJ with the bonding portion A as the leading end of the two-ply sheet PJ in the forward direction, i.e., a direction from the right side to the left side in FIGS. 5A, 5B, 5C, and 5D in the third sheet conveyance passage K3. At this time, the displacement detector 47 detects the lateral registration (i.e., the displacement volume in the width direction or the lateral displacement amount) of the two-ply sheet PJ while the second conveyance roller pair 5 is nipping and conveying the two-ply sheet PJ (step S2 of the flowchart in FIG. 13A).

At this time, the controller 500 causes the moving mechanism 30 to locate the gripper 32 at the gripping position that is inside of the outer circumference of the winding roller 20. In other words, the cam 34 rotates to move to a position at which the cam 34 does not press the arm 31. When the gripper 32 is located at the gripping position as described above, the gripper 32 does not interrupt conveyance of the sheet in the third sheet conveyance passage K3.

The switching members 15 rotate the free end downward and stand by at the standby positions at which the switching members 15 do not interrupt the conveyance of the sheet in the third sheet conveyance passage K3.

Then, as illustrated in FIG. 5B, the third conveyance roller pair 6 conveys the two-ply sheet PJ until the gripped portion B of the two-ply sheet PJ (i.e., the trailing end of the two-ply sheet PJ conveyed in the forward direction, in other words, the one end of the two-ply sheet PJ) passes through the position of the winding roller 20. After the two-ply sheet PJ is further conveyed in the forward direction, the third conveyance roller pair 6 stops the conveyance of the two-ply sheet PJ, as illustrated in FIG. 5C. Specifically, the controller 500 determines whether the third sensor 43 detects the bonding portion A of the two-ply sheet PJ (i.e., the leading end of the two-ply sheet PJ conveyed in the forward direction, that is, the other end of the two-ply sheet PJ) in step S2 of the flowchart in FIG. 13A. When the third sensor 43 has not detected the bonding portion A of the two-ply sheet PJ (NO in step S2 of FIG. 13A), step S2 is repeated until the third sensor 43 detects the bonding portion A of the two-ply sheet PJ. By contrast, when the third sensor 43 has detected the bonding portion A of the two-ply sheet PJ (YES in step S2 of FIG. 13A), in response to the timing of detection of the bonding portion A of the two-ply sheet PJ by the third sensor 43, the controller 500 causes the third conveyance roller pair 6 to convey the two-ply sheet PJ in the forward direction by a predetermined amount X1, in step S3 of the flowchart in FIG. 13A, and stops the conveyance of the two-ply sheet PJ.

At this time, the displacement detector 47 detects the lateral registration (i.e., the lateral displacement volume) of the two-ply sheet PJ. Then, the third conveyance roller pair 6 serving as a displacement adjuster moves in the width direction while the third conveyance roller pair 6 is nipping and conveying the two-ply sheet PJ, so that the lateral registration (i.e., the lateral displacement volume) becomes zero (step S24 of the flowchart in FIG. 13A). The timing to adjust the lateral registration of the two-ply sheet PJ by the third conveyance roller pair 6 serving as a displacement adjuster is not limited to the above-described timing.

Then, as illustrated in FIG. 5C, in response to the temporary stop of the conveyance of the two-ply sheet PJ by the third conveyance roller pair 6, the controller 500 causes the gripper 32 to move from the gripping position to the releasing position, in step S4 of the flowchart in FIG. 13A. In other words, the controller 500 causes the cam 34 to rotate to the position at which the cam 34 presses the arm 31. While the cam 34 presses the arm 31, the gripped portion B of the two-ply sheet PJ can be received between the gripper 32 and the receiving portion 20b of the winding roller 20.

Then, as illustrated in FIG. 5D, the controller 500 causes the third conveyance roller pair 6 to rotate in the reverse direction to start conveyance of the two-ply sheet PJ in the reverse direction in step S5 of the flowchart in FIG. 13A. At this time, the fourth sensor 44 detects the gripped portion B of the two-ply sheet PJ (i.e., the one end of the two-ply sheet PJ, in other words, the leading end of the two-ply sheet PJ conveyed in the reverse direction) to convey the gripped portion B of the two-ply sheet PJ to the gripping position of the winding roller 20.

Subsequently, the controller 500 determines whether the fourth sensor 44 has detected the gripped portion B of the two-ply sheet PJ, in step S6 of the flowchart in FIG. 13A. When the fourth sensor 44 has not detected the gripped portion B (NO in step S6 of FIG. 13A), step S6 is repeated until the fourth sensor 44 detects the gripped portion B of the two-ply sheet PJ. By contrast, when the fourth sensor 44 has detected the gripped portion B (YES in step S6 of FIG. 13A), as illustrated in FIG. 6A, in response to the detection of the gripped portion B of the two-ply sheet PJ by the fourth sensor 44, the controller 500 causes the third conveyance roller pair 6 to convey the two-ply sheet PJ by a predetermined amount X2 until the gripped portion B of the two-ply sheet PJ reaches the predetermined rotational position of the winding roller 20, in other words, the winding start position W (see FIG. 2). Then, the controller 500 causes the third conveyance roller pair 6 to stop the conveyance of the two-ply sheet PJ, in step S7 of the flowchart in FIG. 13A.

Then, as illustrated in FIG. 6B, the gripper 32 is moved from the releasing position to the gripping position while the gripped portion B of the two-ply sheet PJ is at the predetermined rotational position of the winding roller 20 (i.e., the winding start position W), in step S8 of the flowchart in FIG. 13A. In other words, the controller 500 causes the cam 34 to rotate to the position at which the cam 34 does not press the arm 31. While the cam 34 is at the position, as illustrated in FIG. 6B′, the end face of the one end of the two-ply sheet PJ does not contact any member, and the gripped portion B of the two-ply sheet PJ is gripped between the gripper 32 and the receiving portion 20b of the winding roller 20. The winding start position W illustrated in FIG. 2 is the predetermined position of the outer circumferential face of the winding roller 20 at the predetermined rotational position of the winding roller 20. However, at the releasing position in FIG. 6A and the gripping position in FIG. 6B, the outer circumferential face of the winding roller 20 does not exist. For this reason, the winding start position W is a position on a theoretical outer circumferential face of the winding roller 20.

Then, as illustrated in FIG. 6C, the winding roller 20 rotates in the reverse direction (that is, the counterclockwise direction in FIG. 6C) while the gripper 32 grips the two-ply sheet PJ, and the third conveyance roller pair 6 rotates again in the reverse direction together with the winding roller 20. At this time, as the winding roller 20 rotates, the gap C is formed between the first sheet P1 and the second sheet P2 of the two-ply sheet PJ between the winding roller 20 and the third conveyance roller pair 6, as illustrated in FIG. 6D. As the gap C is formed, the first guide 25 and the second guide 26 limit the warp (slack) of the two-ply sheet PJ in the vicinity of the winding roller 20. As a result, the gap C of the two-ply sheet PJ is intensively formed near the third conveyance roller pair 6.

As described above, the leading end of the two-ply sheet PJ in the reverse direction is detected by the fourth sensor 44 that is disposed between the third conveyance roller pair 6 and the winding roller 20 and downstream from the third conveyance roller pair 6 in the reverse direction. Since the controller 500 determines the timing at which the gripper 32 and the receiving portion 20b grip the gripped portion B of the two-ply sheet PJ in response to the timing of detection of the leading end of the two-ply sheet PJ conveyed in the reverse direction by the fourth sensor 44, the gripped portion B of the two-ply sheet PJ can be accurately conveyed to a desired gripping position regardless of variations in the sheet lengths with respect to the sheet conveyance amount X2 as the predetermined amount X2. Note that the size of sheets includes an error even if the sheets are sold as the same size.

Further, the fourth sensor 44 is disposed between the third conveyance roller pair 6 and the winding roller 20 at the position proximate to the winding roller 20. By so doing, the sheet conveyance amount X2 from the detection of the leading end of the two-ply sheet PJ in the reverse direction can be reduced regardless of the sheet length. As a result, the above-described configuration can reduce variation in the sheet conveyance amount X2 (i.e., the predetermined amount X2) and can accurately convey the gripped portion B of the two-ply sheet PJ to the desired gripping position.

Accordingly, the fourth sensor 44 is preferably disposed at the position near the winding roller 20.

Then, the controller 500 causes the third conveyance roller pair 6 to continue to rotate in the reverse direction and the winding roller 20 to start winding the two-ply sheet PJ, as illustrated in FIG. 6D. At the timing at which the third conveyance roller pair 6 has conveyed the two-ply sheet PJ by a conveyance amount that is equal to a predetermined amount X3 since the start of winding of the two-ply sheet PJ by the winding roller 20, the controller 500 causes the third conveyance roller pair 6 to stop the conveyance of the two-ply sheet PJ and the winding roller 20 to stop the winding the two-ply sheet PJ, as illustrated in FIG. 7A, in step S9 of FIG. 13A. While the conveyance and winding of the two-ply sheet PJ are stopped, the two-ply sheet PJ is wound around the winding roller 20 one or more times, and the gap C in the two-ply sheet PJ (i.e., the distance between the first sheet P1 and the second sheet P2 in the vertical direction) is sufficiently widened.

In other words, the bonding portion A of the two-ply sheet PJ is nipped by the third conveyance roller pair 6.

As a result, as illustrated in FIG. 7B, the controller 500 causes the separation members 16 to move to be inserted into the gap C that is sufficiently widened in the two-ply sheet PJ, as illustrated in FIG. 7B, in step S10 of FIG. 13A. In other words, as illustrated in FIGS. 10 and 11A, each of the separation members 16 in pair is moved from the standby position in FIG. 11A to the separation position in FIG. 11B. At this time, the third conveyance roller pair 6 functioning as a displacement adjuster has adjusted the lateral registration (i.e., the lateral displacement volume) of the two-ply sheet PJ to zero. Due to such a configuration, the separation members 16 are smoothly inserted into the gap C of the two-ply sheet PJ (step S24 of the flowchart in FIG. 13A).

Then, as illustrated in FIG. 7C, the third conveyance roller pair 6 and the winding roller 20 start rotating in the forward direction, in other words, in the clockwise direction while the separation members 16 are inserted in the gap C, in step S11 of FIG. 13A.

At this time, when the winding roller 20 can convey the two-ply sheet PJ along with rotation of the winding roller 20 in the forward direction (i.e., the clockwise direction), the bonding portion A of the two-ply sheet PJ may not be nipped by the third conveyance roller pair 6. In other words, as the winding roller 20 rotates in the forward direction, the bonding portion A of the two-ply sheet PJ may be conveyed toward the third conveyance roller pair 6. Then, the third conveyance roller pair 6 may convey the two-ply sheet PJ while nipping the bonding portion A of the two-ply sheet PJ.

Then, as illustrated in FIG. 8A, the controller 500 causes the third conveyance roller pair 6 and the winding roller 20 to stop rotating in the forward direction after the third conveyance roller pair 6 has conveyed the two-ply sheet PJ in the forward direction by a predetermined amount X4, in step S12 of FIG. 13A. At this time, the two-ply sheet PJ is not wound around the gripper 32 and the gripper 32 can release the gripping of the gripped portion B of the two-ply sheet PJ at the winding start position W. In other words, at the winding start position W, the gripper 32 can move from the gripping position at which the gripper 32 grips the gripped portion B of the two-ply sheet PJ to the releasing position.

Then, the gripper 32 is moved from the gripping position to the releasing position while the two-ply sheet PJ is not wound around the gripper 32, so that the gripper 32 is on the third sheet conveyance passage K3, in step S13 of FIG. 13B. In other words, the cam 34 rotates as illustrated in FIG. 2B to move to the position at which the cam 34 presses the arm 31. By so doing, the gripper 32 releases the gripping of the two-ply sheet PJ. In the present embodiment, the cam 34 in the moving mechanism 30 moves to release the gripping of the two-ply sheet PJ by the gripper 32. However, when the pulling force by conveyance of the two-ply sheet PJ by the third conveyance roller pair 6 is greater than the gripping force of the gripper 32 to grip the two-ply sheet PJ, the gripping of the two-ply sheet PJ by the gripper 32 can be released by pulling the two-ply sheet PJ from the gripper 32 due to conveyance of the two-ply sheet PJ by the third conveyance roller pair 6 without moving the cam 34 in the moving mechanism 30.

After step S13, as illustrated in FIG. 8B, the controller 500 causes the third conveyance roller pair 6 to rotates in the forward direction again to start conveyance of the two-ply sheet PJ in the forward direction, in step S14 of FIG. 13B. In response to the start of the conveyance of the two-ply sheet PJ in the forward direction, the fourth sensor 44 detects the gripped portion B of the two-ply sheet PJ, i.e., the one end of the two-ply sheet PJ and the trailing end of the two-ply sheet PJ conveyed in the forward direction. In addition, after the gripped portion B of the two-ply sheet PJ, i.e., the one end of the two-ply sheet PJ and the trailing end of the two-ply sheet PJ in the forward direction, passes over the switching members 15, the gripper 32 is moved from the releasing position to the gripping position and the switching members 15 are rotated in the clockwise direction from the standby position to the switching position. Then, as illustrated in FIG. 8B, when the gripped portion B of the two-ply sheet PJ, i.e., the trailing end of the two-ply sheet PJ conveyed in the forward direction reaches near the separation members 16, the trailing ends of the first sheet P1 and the second sheet P2 of the two-ply sheet PJ are separated and largely opened.

Then, the controller 500 determines whether the third conveyance roller pair 6 conveys the two-ply sheet PJ by a predetermined amount X5 in response to the timing at which the fourth sensor 44 detects the trailing end of the two-ply sheet PJ conveyed in the forward direction, in other words, after the fourth sensor 44 has detected the gripped portion B of the two-ply sheet PJ, in step S15 of FIG. 13B. When the third conveyance roller pair 6 does not convey the two-ply sheet PJ by the predetermined amount X5 after the fourth sensor 44 has detected the gripped portion B of the two-ply sheet PJ (NO in step S15 of FIG. 13B), step S15 is repeated until the third conveyance roller pair 6 conveys the two-ply sheet PJ by the predetermined amount X5 after the fourth sensor 44 has detected the gripped portion B of the two-ply sheet PJ. In contrast, when the third conveyance roller pair 6 conveys the two-ply sheet PJ by the predetermined amount X5 after the fourth sensor 44 has detected the gripped portion B of the two-ply sheet PJ (YES in step S15 of FIG. 13B), the controller 500 causes the third conveyance roller pair 6 to stop conveying the two-ply sheet PJ and causes the separation members 6 to move in the reverse direction to start conveyance of the two-ply sheet PJ in the reverse direction, as illustrated in FIG. 8C, in step S16 of FIG. 13B. At this time, since the free ends of the switching members 15 are located at the switching position where the entry of the two-ply sheet PJ into the third sheet conveyance passage K3 is blocked, the two sheets, in other words, the first sheet P1 and the second sheet P2 separated from each other are guided to the first branched sheet conveyance passage K4 and the second branched sheet conveyance passage K5, respectively, as illustrated in FIG. 8C. At this time, the fifth sensor 45 (see FIG. 1) detects the bonding portion A of the two-ply sheet PJ (i.e., the other end of the two-ply sheet PJ and the trailing end of the two-ply sheet PJ conveyed in the reverse direction) so as to convey and stop the two-ply sheet PJ while the third conveyance roller pair 6 nips the portion near the bonding portion A of the two-ply sheet PJ.

Subsequently, as illustrated in FIG. 9A, in response to the timing at which the fifth sensor 45 (see FIG. 1) detects the trailing end of the two-ply sheet PJ conveyed in the reverse direction, that is, the bonding portion A of the two-ply sheet PJ in step S17 of FIG. 13B. Then, the controller 500 causes the third conveyance roller pair 6 to convey the two-ply sheet PJ by a predetermined amount X6 and stop, in step S18 of FIG. 13B. At this time, the bonding portion A of the two-two-ply sheet PJ is at the nipping position of the third conveyance roller pair 6 or a position slightly left and downstream from the nip region in the forward direction. In other words, the other end of the two-ply sheet PJ is nipped by the third conveyance roller pair 6.

Then, as illustrated in FIG. 9A, the controller 500 starts to convey the inner sheet PM from the second sheet tray 12 (see FIG. 1), in step S19 of FIG. 13B. At this time, the third sensor 43 detects the leading end of the inner sheet PM (i.e., the other end of the inner sheet PM and the leading end in the forward direction). In addition, as illustrated in FIG. 9B, the separation members 16 move to the respective standby positions.

Further, as illustrated in FIGS. 9A and 9B, the displacement detector 47 detects the lateral registration (i.e., the lateral displacement volume) of the inner sheet PM while the second conveyance roller pair 5 is nipping and conveying the inner sheet PM (step S20 of the flowchart in FIG. 13B). Then, the third conveyance roller pair 6 serving as a displacement adjuster moves in the width direction while nipping the two-ply sheet PJ so that the lateral registration (i.e., the lateral displacement volume) of the two-ply sheet PJ that is equal to the lateral registration (i.e., the lateral displacement volume) of the inner sheet PM detected by the displacement detector 47, as illustrated in FIG. 9B (step S25 of the flowchart in FIG. 13B).

Subsequently, as illustrated in FIG. 9C, in response to the timing at which the third sensor 43 detects the leading end of the inner sheet PM in the forward direction (step S20 in FIG. 13B), the controller 500 causes the second conveyance roller pair 5 to convey the inner sheet PM by the predetermined amount X7, and then the third conveyance roller pair 6 starts the conveyance of the two-ply sheet PJ in the forward direction again, in step S21 of FIG. 13B. At this time, the inner sheet PM is accurately nipped at a desired position between the first sheet P1 and the second sheet P2 of the two-ply sheet PJ. Thus, the controller 500 finishes the operations to insert the inner sheet PM between the first sheet P1 and the second sheet P2 in the two-ply sheet PJ, in step S31.

The third conveyance roller pair 6 conveys the two-ply sheet PJ enclosing the inner sheet PM in the forward direction, then the two-ply sheet PJ enclosing the inner sheet PM is conveyed to the lamination processing device 50 via the relay conveyor 90, and the sheet laminating operation is performed on the two-ply sheet PJ in the lamination processing device 50 (step S32).

After the sheet laminating operation has been performed on the enclosed two-ply sheet PJ (i.e., the two-ply sheet PJ in which the inner sheet PM is enclosed), the enclosed two-ply sheet PJ is ejected from the lamination processing device 50 to be stacked on the ejection tray 13 (see FIG. 1, for example).

In the state illustrated in FIG. 7A of the present embodiment, the gap C is formed between the first sheet P1 and the second sheet P2 of the two-ply sheet PJ in the non-bonding portion near the bonding portion A of the two-ply sheet PJ to peel (separate) the two sheets, i.e., the first sheet P1 and the second sheet P2.

By contrast, in the state illustrated in FIG. 7A of the present embodiment, the bonding portion A of the two-ply sheet PJ may be set as the gripped portion B if the two-ply sheet PJ is gripped by the third conveyance roller pair 6 with sufficiently strong force. In other words, in FIGS. 6A, 6B, 6B′, 6C, 6C′, and 6D, while the bonding portion A of the two-ply sheet PJ is gripped by the gripper 32 and the receiving portion 20b of the winding roller 20, the two-ply sheet PJ is wound around the winding roller 20, and the non-bonding portion is nipped and conveyed by the third conveyance roller pair 6. At this time, the third conveyance roller pair 6 rotates to convey the first sheet P1 and the second sheet P2 of the two-ply sheet PJ in synchrony with each other without slipping. For example, increasing the nip pressure of the third conveyance roller pair 6, using roller material having a large coefficient of friction, or controlling the driving method of the rollers of the third conveyance roller pair 6 reduces occurrence of slippage of the two sheets P1 and P2 (i.e., the first sheet P1 and the second sheet P2). By so doing, a desired gap such as the gap C is formed in the two-ply sheet PJ to peel (separate) the two sheets P1 and P2. The above-described configuration can also reduce the number of times of conveyance of the two-ply sheet PJ until the inner sheet PM is inserted into the two-ply sheet PJ.

A detailed description is now given of the configuration and functions of the sheet processing system 100 according to an embodiment of the present disclosure, with reference to FIGS. 14 to 19.

FIG. 14 is a diagram illustrating the sheet processing system 100, with two-ply sheets placed on a bypass sheet feeder attached to the sheet processing device 60.

As illustrated in FIG. 14 (and FIG. 1), the sheet processing system 100 according to the present embodiment may include a bypass sheet feeder 91 serving as a sheet feeder to feed a bypass two-ply sheet PJ′ to the lamination processing device 50 without passing the sheet processing device 60 that includes the sheet separator 1 and the relay conveyor 90. The bypass two-ply sheet PJ′ serves as a two-ply sheet in which the inner sheet is manually enclosed between the two sheets.

In other words, the sheet processing system 100 according to the present embodiment has modes changeable between an “automatic mode” and a “manual mode”. In the automatic mode, a sheet separating operation, a sheet inserting operation, and a sheet laminating operation are automatically and sequentially performed. In the manual mode, a sheet separating operation and a sheet inserting operation are manually performed and a sheet laminating operation is automatically performed. The automatic mode uses the sheet processing device 60 including the sheet separator 1 and the relay conveyor 90, and the lamination processing device 50. The manual mode uses the bypass sheet feeder 91 (as a sheet feeder) and the lamination processing device 50.

As described above, the reason why the manual mode is provided separately from the automatic mode is that the sheet sizes and thicknesses of the two-ply sheet PJ and the inner sheet PM that perform a series of sheet separating operation, sheet inserting operation, and sheet laminating operation are limited in the automatic mode due to the limitations of the winding roller 20 and the conveyance passages. In other words, the manual mode is used to perform the sheet laminating operation on a two-ply sheet PJ′ having the size and thickness out of a given range and cannot be processed in the automatic mode.

More specifically, referring to FIGS. 1 and 14, the relay conveyor 90 of the sheet processing device 60 is supported by the sheet separator 1 to be rotatable around a support shaft 90a.

The “automatic mode” is executed in a state where the relay conveyor 90 is rotated about the support shaft 90a in a predetermined direction (a direction opposite to the arrow direction in FIG. 14) and is in contact with (or in proximity to) the sheet separator 1 and the lamination processing device 50. In other words, the automatic mode is executed in the state of FIG. 1 in the flow described above with reference to, for example, FIGS. 13A and 13B. The relay conveyor 90 is positioned to at least one of the sheet separator 1 or the lamination processing device 50 in the automatic mode. Specifically, the state of FIG. 1 is maintained by fitting the fitting target portion of the relay conveyor 90 into the fitting portion disposed in the sheet separator 1 or the lamination processing device 50.

In the present embodiment, the relay conveyor 90 is substantially in close contact with the sheet separator 1 and the lamination processing device 50 in the automatic mode. However, the relay conveyor 90 may be close to the sheet separator 1 and the lamination processing device 50 with a clearance.

In contrast, the “manual mode” is executed in a state where the relay conveyor 90 is rotated about the support shaft 90a in a direction (arrow direction in FIG. 14) opposite to the predetermined direction and is separated from the sheet separator 1 and the lamination processing device 50. In other words, the manual mode is executed in the state of FIG. 14.

The state of FIG. 14 is maintained by the inclined bottom face of the relay conveyor 90 coming into contact with the installation face by rotating in the direction indicated by arrow in FIG. 14 after releasing the fitting between the fitting portion formed in the sheet separator 1 or the lamination processing device 50 and the fitting target portion of the relay conveyor 90.

A detailed description is given of the manual mode.

As illustrated in FIG. 14, the bypass sheet feeder 91 (serving as a sheet feeder on which the bypass two-ply sheet PJ′ is placed in the manual mode) is a part of the relay conveyor 90 when rotated around the support shaft 90a. In other words, a part of the relay conveyor 90 functions as a guide for feeding the bypass two-ply sheet PJ′.

The bypass sheet feeder 91 corresponds to the ceiling of the relay conveyor 90 and a foldable tray 91x that is folded and overlapped with the ceiling is rotated (unfolded) around a hinge 91a to the position at which the foldable tray 91x contacts a stopper. In other words, the bypass sheet feeder 91 functions by rotating the foldable tray 91x around the hinge 91a to the position in FIG. 14 with the relay conveyor 90 rotated at the position of FIG. 14. At this time, the foldable tray 91x is extended to a position where the bypass two-ply sheet PJ′ can be fed toward the nip region of the rollers of the sixth sheet conveyance roller pair 9.

The bypass sheet feeder 91 is not limited to the configuration including the foldable tray 91x. For example, the bypass sheet feeder 91 may be a drawer type tray that can be pulled out toward the lamination processing device 50 in the manual mode.

“The manual mode” is executed as follows.

To execute the manual mode, a user (operator) initially rotates the relay conveyor 90 in the state of FIG. 1 to the position illustrated in FIG. 14 to rotate the foldable tray 91x to the position illustrated in FIG. 14.

Then, a bypass two-ply sheet PJ′ (two-ply sheet) is placed on the bypass sheet feeder 91 (serving as a sheet feeder) illustrated in FIG. 14. The “bypass two-ply sheet PJ′” is a two-ply sheet that is a film sheet (lamination sheet) in which a user (operator) has separated two sheets of the film sheet and inserted an inner sheet between the separated two sheets. The bypass two-ply sheet PJ′ placed on the bypass sheet feeder 91 with the leading end of which set in contact with the nip region of the sixth sheet conveyance roller pair 9.

When the user (operator) presses the START button of the operation display panel 49, the bypass two-ply sheet PJ′ placed on the bypass sheet feeder 91 is fed by the sixth sheet conveyance roller pair 9. The bypass two-ply sheet PJ′ fed by the sixth sheet conveyance roller pair 9 is subjected to the sheet laminating operation at the position of the thermal pressure roller pair 51 and ejected to the ejection tray 13 after the sheet laminating operation.

The thermal pressure roller pair 51 disposed in the lamination processing device 50 is to apply heat and pressure to a two-ply sheet PJ or a bypass two-ply sheet PJ′. The sixth sheet conveyance roller pair 9 functions as a conveyance roller pair to convey a two-ply sheet PJ conveyed through the relay conveyor 90 or a bypass two-ply sheet PJ′ placed on the bypass sheet feeder 91 toward the thermal pressure roller pair 51.

As described above, the sheet processing system 100 according to the present embodiment can include the bypass sheet feeder 91 to feed (convey) a bypass two-ply sheet PJ′ manually prepared by a user directly to the lamination processing device 50 without causing the bypass two-ply sheet PJ′ to pass through the sheet processing device 60 including the sheet separator 1 and the relay conveyor 90 (in other words, the manual mode is executable separately from the automatic mode).

Due to such a configuration, even if the sheet size and thickness of a two-ply sheet PJ or an inner sheet PM on which a series of a sheet separating operation, a sheet inserting operation, and a sheet laminating operation is performed in the automatic mode are limited, the sheet laminating operation can be performed in the manual mode on a two-ply sheet PJ′ having the sheet size and thickness out of the given range. Accordingly, the convenience for a user is enhanced.

Referring to FIG. 15, in the sheet processing system 100 according to the present embodiment, the lamination processing device 50 is detachably attached to the sheet separator 1 of the sheet processing device 60.

FIG. 15 is a diagram illustrating the sheet processing system 100, with the lamination processing device 50 detached from the sheet processing device 60, according to an embodiment of the present disclosure.

In other words, the lamination processing device 50 can be changed between a state where the lamination processing device 50 is attached to the sheet processing device 60 as illustrated in FIGS. 1 and 14 and a state where the lamination processing device 50 is detached from the sheet processing device 60 as illustrated in FIG. 15.

Due to such a configuration, the operability in maintenance of the lamination processing device 50 can be enhanced.

In the sheet processing system 100, the lamination processing device 50 is positioned to the sheet separator 1 of the sheet processing device 60 as illustrated in FIGS. 1 and 14.

Specifically, referring to FIGS. 14 and 15, the lamination processing device 50 is determined to the position facing the sheet separator 1 by positioning members, which are first positioning members 53 and second positioning members 54, disposed in the sheet separator 1. The first positioning members 53 are a pair of positioning members that determine the position in a direction orthogonal to the width direction of the lamination processing device 50 with respect to the sheet separator 1 (the left-and-right direction in FIGS. 14 and 15) and sandwich the lamination processing device 50. The second positioning members 54 are a pair of positioning members that determine the position in the width direction of the lamination processing device 50 with respect to the sheet separator 1 (the direction perpendicular to the drawing sheet of FIGS. 14 and 15) and are spaced away from each other in the width direction so as to sandwich the lamination processing device 50. By thus positioning the lamination processing device 50 with respect to the sheet separator 1, smooth conveyance of a two-ply sheet PJ and sheet processing from the sheet separator 1 to the lamination processing device 50 via the relay conveyor 90 can be achieved in the automatic mode.

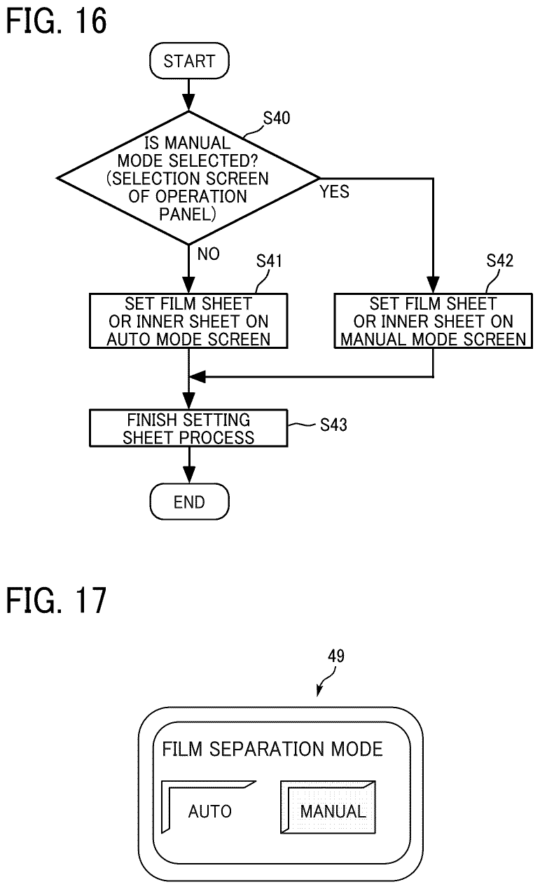

A description is now given of control of modes between the automatic mode and the manual mode executed in the sheet processing system 100, with reference to FIGS. 16, 17, 18A, 18B, 19A, and 19B.

FIG. 16 is a flowchart of control of changing the automatic mode and the manual mode, according to of an embodiment of the present disclosure.

FIG. 17 is a diagram illustrating a display screen of the operation display panel 49, for selecting the automatic mode or the manual mode, according to an embodiment of the present disclosure.

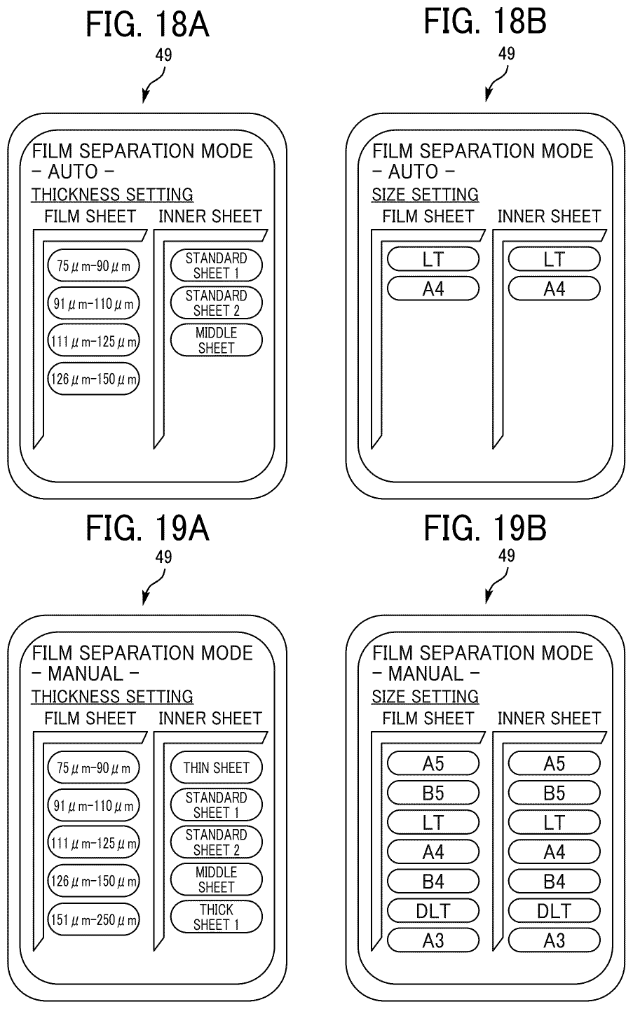

FIGS. 18A and 18B are diagrams, each illustrating a display screen of the operation display panel 49, when setting a sheet in the automatic mode, according to an embodiment of the present disclosure.

FIGS. 19A and 19B are diagrams, each illustrating a display screen of the operation display panel 49, when setting a sheet in the manual mode, according to an embodiment of the present disclosure.

As illustrated in the flowchart of FIG. 16, the controller 500 determines whether the manual mode is selected (step S40). In other words, the controller 500 determines which one of the automatic mode and the manual mode is selected by a user. Specifically, such a mode selection is performed based on an input of the instruction from a user through a selection screen of the operation display panel 49 as illustrated in FIG. 17.

When the automatic mode is selected (NO in step S40), the user inputs the sheet thicknesses (sheet types) and sheet sizes of a two-ply sheet PJ (film sheet) or an inner sheet PM (inner sheet) from the input screen of the operation display panel 49 as illustrated in FIGS. 18A and 18B (step S41), and then end the setting (step S43). Then, the automatic mode (film separation mode) using a two-ply sheet PJ (film sheet) and an inner sheet PM (inner sheet) of the sheet thickness and sheet size set on the operation display panel 49 is executed.

On the other hand, when the manual mode is selected (YES in step S40), the user inputs the sheet thicknesses (sheet types) and sheet sizes of a two-ply sheet PJ (film sheet) or an inner sheet PM (inner sheet) from the input screen of the operation display panel 49 as illustrated in FIGS. 19A and 19B (step S42), and then end the setting (step S43). Then, the manual mode (film separation mode) using a two-ply sheet PJ (film sheet) and an inner sheet PM (inner sheet) of the sheet thickness and sheet size set on the operation display panel 49 is executed.

### Modification 1

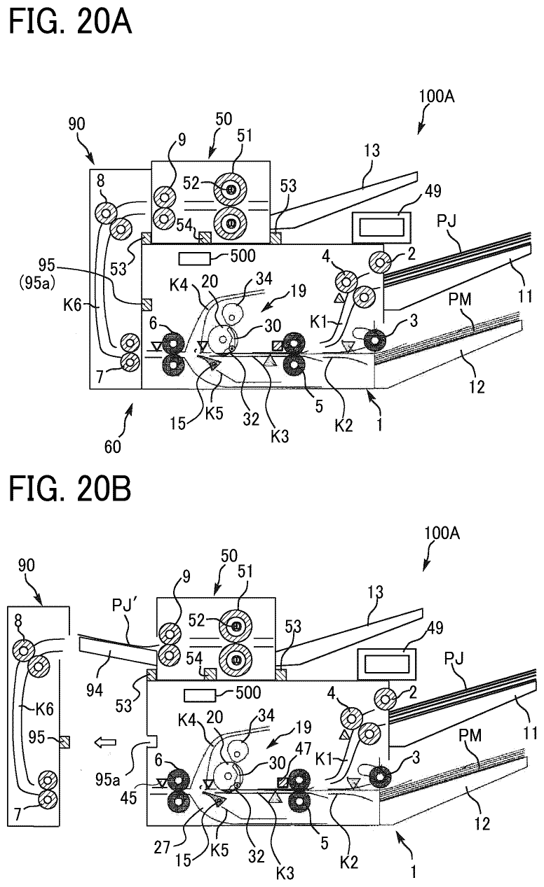

FIGS. 20A and 20B are diagrams, each illustrating a sheet processing system 100A according to Modification 1 of the above-described embodiments of the present disclosure.

As illustrated in FIGS. 20A and 20B, the sheet processing system 100A according to Modification 1 is different from the sheet processing system 100 illustrated in FIGS. 1 and 14 in the method of attaching and detaching the relay conveyor 90.

In Modification 1, as illustrated in FIG. 20A, the automatic mode is executed when the relay conveyor 90 is moved in a given direction (the right direction in FIG. 20A and substantially horizontal) and is in contact with (or in proximity to) the sheet separator 1 and the lamination processing device 50. The relay conveyor 90 is positioned to at least the sheet separator 1 or the lamination processing device 50 in the automatic mode. Specifically, in Modification 1, the state of the sheet processing system 100A illustrated in FIG. 20A is maintained by fitting a projection 95 (fitting target portion) of the relay conveyor 90 into a recess 95a (fitting portion) disposed in the sheet separator 1 or the lamination processing device 50. The method of positioning the relay conveyor 90 is not limited to this method. For example, the relay conveyor 90 may have multiple projections 95 (and the sheet separator 1 may have multiple recesses 95a) in the width direction or the height direction.

In contrast, as illustrated in FIG. 20B, the manual mode is executed when the relay conveyor 90 is rotated in a direction opposite to the above-described given direction (the left direction in FIG. 20B and substantially horizontal) and is separated from the sheet separator 1 and the lamination processing device 50. At this time, after the relay conveyor 90 is detached from the sheet separator 1 and the lamination processing device 50, a bypass tray 94 serving as a bypass sheet feeder is attached to the lamination processing device 50.

Then, the bypass two-ply sheet PJ′ is placed on the bypass tray 94 attached to the lamination processing device 50 to execute the desired manual mode.

Even in such a configuration, even if the sheet size or the sheet thickness is out of the predetermined range, a desired sheet processing (the sheet laminating operation) can be performed.

### Modification 2

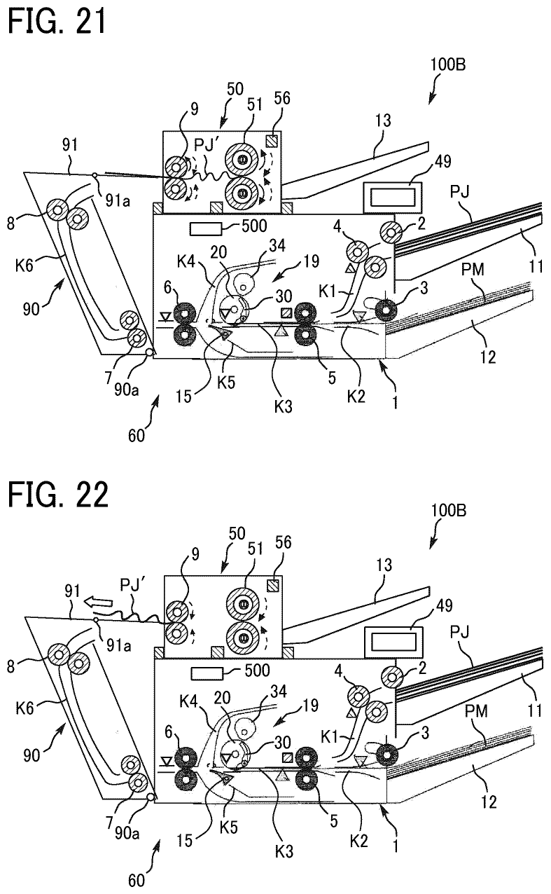

FIG. 21 is a diagram illustrating a sheet processing system according to Modification 2 of the above-described embodiments of the present disclosure.

FIG. 22 is a diagram illustrating a sheet processing system, with a jammed two-ply sheet removed from the sheet processing system of FIG. 21.

As illustrated in FIG. 21, a sheet processing system 100B according to Modification 2 is configured such that the thermal pressure roller pair 51 and the sixth sheet conveyance roller pair 9 (serving as a conveyance roller pair) are rotatable at the same timing in a reverse direction (indicated by broken lines in FIG. 21) with respect to the rotational direction (indicated by solid lines in FIG. 21) in operation in a state where the sheet processing system 100B is stopped.

This configuration of the sheet processing system 100B is, as illustrated in FIG. 21, to easily perform an operation to remove a bypass two-ply sheet PJ′ (or a two-ply sheet PJ) (paper jam handling) when the bypass two-ply sheet PJ′ (or the two-ply sheet PJ) is jammed (the conveyance is stopped due to paper jam) in the lamination processing device 50.

Specifically, as illustrated in FIG. 21, when the bypass two-ply sheet PJ′ is jammed in the lamination processing device 50, the jammed state is detected by a jam detection sensor 56 and the operation of the sheet processing system 100B is stopped. Then, as illustrated in FIG. 22, the user causes the thermal pressure roller pair 51 and the sixth sheet conveyance roller pair 9 to rotate in a reverse direction to convey the jammed bypass two-ply sheet PJ′ to the position of the bypass sheet feeder 91, so that the jammed sheet is removed at the position of the bypass sheet feeder 91.

The method of rotating the thermal pressure roller pair 51 and the sixth sheet conveyance roller pair 9 in the reverse direction may be manual or automatic.

### Modification 3

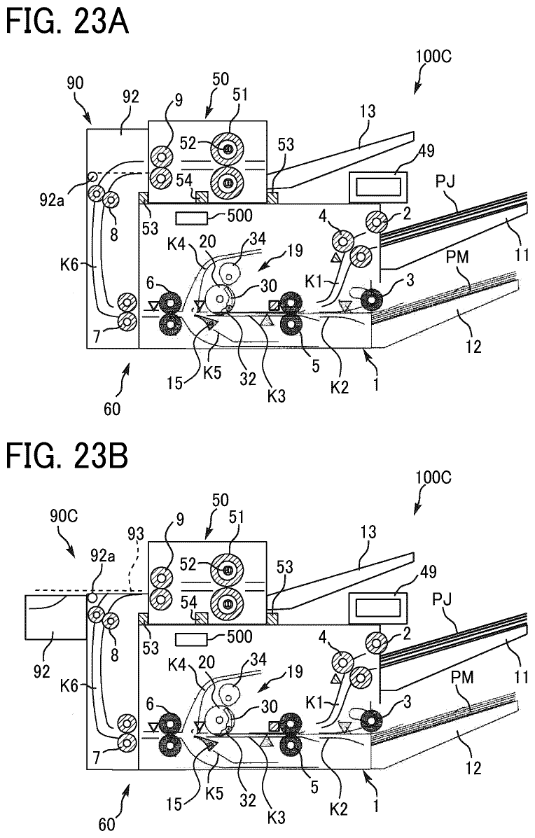

FIG. 23A is a diagram illustrating a sheet processing system in an automatic mode, according to Modification 3 of the above-described embodiments of the present disclosure.

FIG. 23B is a diagram illustrating a sheet processing system in a manual mode, according to Modification 3 of the above-described embodiments of the present disclosure.

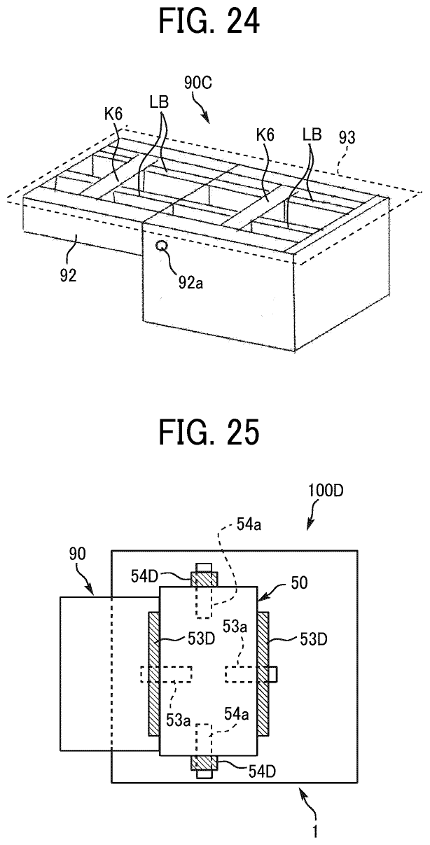

FIG. 24 is a schematic perspective view of the sheet processing system of FIG. 23, with a part of a relay conveyor rotated to form a bypass sheet feeder.

As illustrated in FIGS. 23A, 23B, and 24, in a sheet processing system 100C according to Modification 3, not the entire part of a relay conveyor 90C is rotatable around the support shafts but a part (a pivot 92) of the relay conveyor 90C is rotatable around a support shaft 92a. Then, from the state in the automatic mode illustrated in FIG. 23A to the state in the manual mode illustrated in FIGS. 23B and 24 (the state where the pivot 92 is rotated in the counterclockwise direction around the support shaft 92a), a bypass sheet feeder 93 is formed on the top face of the relay conveyor 90C and a bypass two-ply sheet PJ′ is placed on the bypass sheet feeder 93 to execute the manual mode.

Referring to FIG. 24, in the relay conveyor 90C, as the pivot 92 is rotated around the support shaft 92a to form the bypass sheet feeder 93, a part of the relay sheet conveyance passage K6 (a part of the downstream area) is divided into the pivot 92 and the portion other than the pivot 92. The portion other than the pivot 92 is located at the center of the bypass sheet feeder 93, which does not hinder conveyance of a bypass two-ply sheet PJ′. As illustrated in FIG. 24, the bypass sheet feeder 93 includes multiple ribs LB on which a bypass two-ply sheet PJ′ is placed.

Even in such a configuration, even if the sheet size or the sheet thickness is out of the predetermined range, a desired sheet processing (the sheet laminating operation) can be performed.

Further, the sheet processing system 100C according to Modification 3 is similar to the sheet processing system 100B according to Modification 2 such that the thermal pressure roller pair 51 and the sixth sheet conveyance roller pair 9 can be rotated manually or automatically in the reverse direction for paper jam handling. Since the sheet processing system 100C according to Modification 3 includes the relay conveyor 90C with a part of which (the pivot 92) rotatable around the support shaft 92a, even if a two-ply sheet PJ is jammed in the lamination processing device 50 in the automatic mode, the jammed two-ply sheet PJ can be easily removed by rotating the pivot 92 from the state of FIG. 23A to the state of FIG. 23B.

### Modification 4

A description is given of a sheet processing system according to Modification 4, with reference to FIG. 25.

FIG. 25 is a top view of a sheet processing system 100D according to Modification 4 of the above-described embodiments of the present disclosure.

As illustrated in FIG. 25, in the sheet processing system 100D, similar to the sheet processing system 100 illustrated in FIGS. 1, 14, and 15, the lamination processing device 50 and the sheet processing device 60 (the sheet separator 1) are detachable from each other. The sheet separator 1 includes first positioning members 53D and second positioning members 54D. The first positioning members 53D are a pair of first positioning members for determining the position of the lamination processing device 50 in the direction orthogonal to the width direction. The second positioning members 54D are a pair of second positioning members for determining the position of the lamination processing device 50 in the width direction.

In Modification 4, the first positioning members 53D are movable on first rods 53a extending in a direction orthogonal to the width direction (the left-and-right direction in FIG. 25). Similarly, the second positioning members 54D are movable on second rods 54a extending in the width direction (the vertical direction in FIG. 25). With this configuration, the positions of the first positioning members 53D in the direction orthogonal to the width direction can be adjusted, and the positions of the second positioning members 54D in the width direction can be adjusted. For this reason, the positioning of the lamination processing device 50 relative to the sheet separator 1 can be finely adjusted.

As described above, the sheet processing system 100 according to the present embodiment includes the sheet processing device 60 and the lamination processing device 50. The sheet processing device 60 includes the sheet separator 1 and the relay conveyor 90. Specifically, the sheet separator 1 performs the sheet separating operation to separate the non-bonding portion of the two-ply sheet PJ in which two sheets, which are the first sheet P1 and the second sheet P2, are overlapped and bonded together at one end of the two-ply sheet PJ as the bonding portion A of the two-ply sheet PJ. The sheet separation device 1 then performs the sheet inserting operation to insert the inner sheet PM between the first sheet P1 and the second sheet P2 separated from each other by the sheet separating operation. The relay conveyor 90 conveys the two-ply sheet PJ from the sheet separator 1 toward the lamination processing device 50.

The lamination processing device 50 performs the sheet laminating operation on the two-ply sheet PJ with the inner sheet PM enclosed between the first sheet P1 and the second sheet P2 that are separated by the sheet separator 1. The two-ply PJ with the inner sheet PM enclosed between the first sheet P1 and the second sheet P2 may be referred to as an “enclosed two-ply sheet.”

Then, the sheet processing system 100 may include the bypass sheet feeder 91 (serving as a sheet feeder) for feeding a bypass two-ply sheet PJ′ directly to the lamination processing device 50 without passing the sheet processing device 60 that includes the sheet separator 1 and the relay conveyor 90. The bypass two-ply sheet PJ′ is in the state where the inner sheet PM is manually enclosed between the two sheets.

Accordingly, even if the sheet size or the sheet thickness is out of the predetermined range, a desired sheet processing (the sheet laminating operation) can be performed.

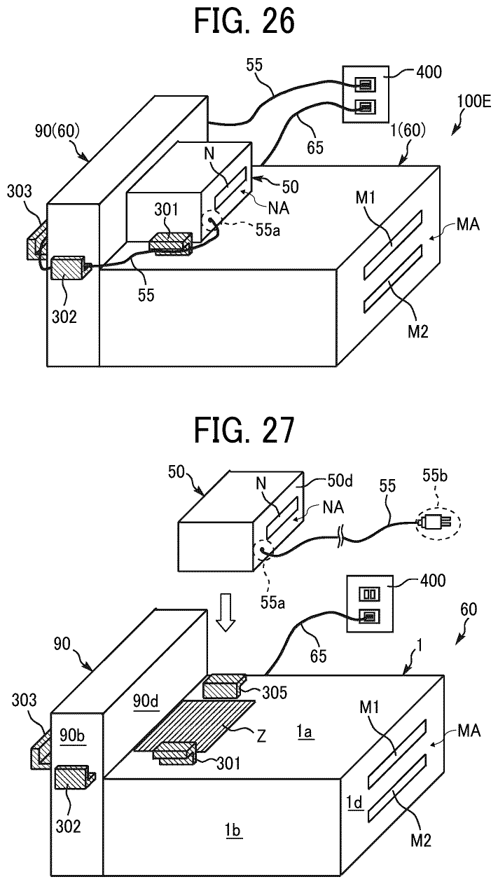

A detailed description is now given of the configuration and functions of a sheet processing system 100E according to an embodiment of the present disclosure, with reference to FIGS. 26 to 28.

FIG. 26 is a schematic perspective view of the sheet processing system 100E according to an embodiment of the present disclosure.

FIG. 27 is a schematic perspective view of the sheet processing system 100E of FIG. 26, when a lamination processing device is attached to the sheet processing device 60.

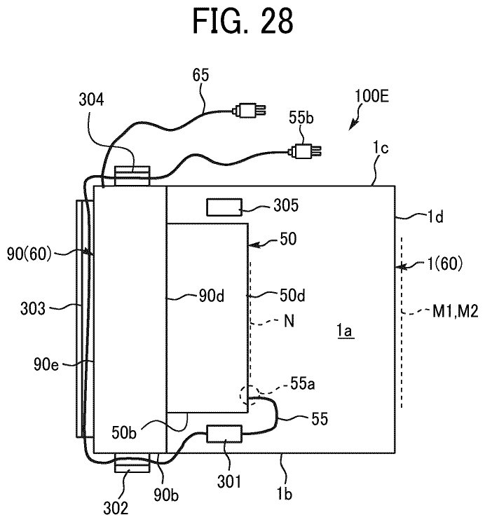

FIG. 28 is a schematic top view of the sheet processing system 100E.

As described above, with reference to, for example, FIG. 1, the sheet processing system 100E according to the present embodiment includes the sheet processing device 60 and the lamination processing device 50.

In the present embodiment, the sheet processing device 60 includes the sheet separator 1 and the relay conveyor 90.

The sheet separation device 1 performs a sheet separating operation and a sheet inserting operation. To be more specific, the sheet separation device 1 performs the sheet separating operation to separate the non-bonding portion of the two-ply sheet PJ in which two sheets, which are the first sheet P1 and the second sheet P2, are overlapped and bonded together at one end of the two-ply sheet PJ as the bonding portion A of the two-ply sheet PJ. The sheet separation device 1 then performs the sheet inserting operation to insert the inner sheet PM between the first sheet P1 and the second sheet P2 separated from each other by the sheet separating operation. The relay conveyor 90 conveys the enclosed two-ply sheet, which is the two-ply sheet PJ with the inner sheet PM enclosed between the first sheet P1 and the second sheet P2, from the sheet separator 1 toward the lamination processing device 50.

The lamination processing device 50 performs a sheet laminating operation on the two-ply sheet PJ with the inner sheet PM enclosed between the first sheet P1 and the second sheet P2 that are separated by the sheet separator 1. The two-ply PJ with the inner sheet PM enclosed between the first sheet P1 and the second sheet P2 may be referred to as an “enclosed two-ply sheet.”

In the present embodiment, referring now to FIGS. 26 and 27, the lamination processing device 50 is detachably attached to (the sheet separator 1 and the relay conveyor 90 of) the sheet processing device 60. In other words, the lamination processing device 50 is attachable to the sheet processing device 60 as illustrated in FIG. 26 (and FIG. 1) and is detachable from the sheet processing device 60 as illustrated in FIG. 27.

More specifically, referring to FIG. 27, the lamination processing device 50 is detachably attached to an installation surface (the area of the region indicated by reference sign Z) that is smaller than the area of the top face 1a of the sheet separator 1. In other words, as illustrated in FIG. 28, the lamination processing device 50 is disposed within the area of the top face 1a of the sheet separator 1, when the sheet processing system 100 is viewed from above.

Further, referring to FIG. 26 (and FIG. 1), the relay conveyor 90 is disposed projecting at a position higher than the top face 1a of the sheet separator 1 on the side face of the sheet separator 1 (the left side in FIG. 28). The projected portion of the relay conveyor 90 is coupled to the lamination processing device 50 (to deliver the two-ply sheet PJ). In other words, the sheet processing device 60 including the sheet separator 1 and the relay conveyor 90 is substantially L-shaped when viewed from a front side face 1b of the sheet processing device 60.

The lamination processing device 50 can be used as a device that performs the sheet laminating operation separately, with the lamination processing device 50 separated from the sheet processing device 60.

Specifically, as illustrated in FIG. 27 (and FIG. 26), the lamination processing device 50 includes a power cord 55 that is connectable to a commercial power supply 400. The lamination processing device 50 can be used as a standalone device by the power supply from the commercial power supply 400 with the plug 55b of the power cord 55 inserted to the outlet of the commercial power supply 400.

In the present embodiment, when the lamination processing device 50 is used as a standalone device, the posture of the lamination processing device 50 is assumed to be left and right reversed with respect to the posture of the lamination processing device 50 in FIG. 26 (the posture when the lamination processing device 50 is attached to the sheet processing device 60). In other words, when the lamination processing device 50 is used as a standalone device, it is assumed that the two-ply sheet PJ is manually fed from the right side of the lamination processing device 50 and the laminated two-ply sheet PJ is ejected from the left side of the lamination processing device 50, giving priority to the operability for a right-handed operator. For this reason, a root portion 55a of the power cord 55 is located at a position close to the commercial power supply when the lamination processing device 50 is used as a standalone device. The root portion 55a is exposed to the exterior of the lamination processing device 50 and the far end of the power cord 55 (FIG. 26) is connected to the power source unit in the lamination processing device 50.

On the other hand, the sheet processing device 60 can be used as a standalone device that performs the sheet separating operation and the sheet inserting operation alone with the lamination processing device 50 detached from the sheet processing device 60.

Specifically, as illustrated in FIG. 27 (and FIG. 26), the sheet processing device 60 includes a power cord 65 that is connectable to the commercial power supply 400. Then, the sheet processing device 60 can be used as a standalone device by the power supply from the commercial power supply 400 with the plug of the power cord 65 inserted to the outlet of the commercial power supply 400.

Referring to FIGS. 26 and 28, in the sheet processing system 100E according to the present embodiment, the sheet processing device 60 includes cord holders 301, 302, and 303 to hold (guide) the power cord 55 extending from the lamination processing device 50 at a position where the sheet feeding operation of the two sheets, which are the first sheet P1 and the second sheet P2 to be conveyed to the sheet processing device 60, and the sheet ejecting operation of the laminated two-ply sheet PJ to be ejected from the lamination processing device 50 are not hindered.

In other words, the sheet processing device 60 includes the cord holders 301, 302, and 303 to hold the power cord 55 of the lamination processing device 50 at the position away from feeding ports M1 and M2 disposed in a right side face 1d of the sheet separator 1 and an ejection port N of the lamination processing device 50.

To be more specific, as illustrated in FIGS. 26 and 27, the sheet separator 1 of the sheet processing device 60 includes the feeding ports M1 and M2 from which the two sheets and the inner sheet are fed and is on one of side faces of the sheet separator 1, and a feeding area MA in the vicinity of the feeding ports M1 and M2. Similarly, the lamination processing device 50 includes the ejection port N from which the laminated two-ply sheet PJ bonded by the lamination processing device 50 is ejected, and an ejection area NA in the vicinity of the ejection port N. The cord holders 301, 302, and 303 hold the power cords 55 and 65 to be extended outside the feeding area MA and the ejection area NA.

Specifically, in the present embodiment, a face that is opposite to the commercial power supply 400 to which the power cord 55 of the lamination processing device 50 is connected is referred to as a “rear side face”, a face that is opposite to the rear side face is referred to as a “front side face”, a face that is on the right side from the front side face is referred to as a “right side face”, and a face that is on the left side from the front side face is referred to as a “left side face”. In the present embodiment, the relay conveyor 90 is disposed on the left side face of the sheet separator 1 and the lamination processing device 50. In other words, the sheet separator 1 and the lamination processing device 50 are coupled to a right side face 90d of the relay conveyor 90 (see FIGS. 27 and 28).

The ejection port N through which the laminated two-ply sheet PJ is ejected is disposed on a right side face 50d of the lamination processing device 50 (see FIGS. 27 and 28).

As illustrated in FIGS. 26 and 28, the root portion 55a of the power cord 55 of the lamination processing device 50 is disposed on the right side face 50d of the lamination processing device 50 at a position close to the front side face 50b from the ejection port N.

Referring now to FIGS. 26 to 28, in the present embodiment, a first cord holder 301, a second cord holder 302, and a third cord holder 303 are disposed each as a cord holder.

The first cord holder 301 is disposed on an upper face 1a of the sheet separator 1 at a position close to the front side face 1b from the lamination processing device 50. The first cord holder 301 is an L-shaped member projecting upward from the upper face 1a of the sheet separator 1.

The second cord holder 302 is on the front side face 90b of the relay conveyor 90. The second cord holder 302 is an L-shaped member projecting forward from the front side face 90b of the relay conveyor 90.

The third cord holder 303 is on the left side face 90e of the relay conveyor 90. The third cord holder 303 is an L-shaped member projecting to the left side from the left side face 90e of the relay conveyor 90.

The power cord 55 is bent from the root portion 55a toward the front side face, held (guided) by the first cord holder 301 on the front side face 50b of the lamination processing device 50, held (guided) by the second cord holder 302 at the position of the front side face 90b of the relay conveyor 90, further held (guided) by the third cord holder 303 at the position of the left side face 90e of the relay conveyor 90, and bent toward the rear side face 1c of the sheet separator 1. Under this condition, the plug 55b of the power cord 55 is inserted into the outlet of the commercial power supply 400.

Referring to the drawings such as FIG. 28, in the present embodiment, a fourth cord holder 304 and a fifth cord holder 305 are further disposed separately from the first cord holder 301, the second cord holder 302, and the third cord holder 303.

The fourth cord holder 304 is an L-shaped member projecting backward from a rear side face 90c of the relay conveyor 90. In the present embodiment, as illustrated in FIG. 28, the power cord 55 held by the first cord holder 301, the second cord holder 302, and the third cord holder 303 may be held by the fourth cord holder 304.

The fifth cord holder 305 is disposed on the upper face 1a of the sheet separator 1 at a position close to the rear side face 1c of the sheet separator 1 from the lamination processing device 50 and is an L-shaped member projecting upward from the upper face 1a of the sheet separator 1. In the present embodiment, the fifth cord holder 305 is not used but can be used depending on the arrangement of the power cord 55.

As described above, in the sheet processing system 100E according to the present embodiment, the lamination processing device 50 is detachably attached to the sheet processing device 60, and the lamination processing device 50 has the power cord 55 that is dedicated to the lamination processing device 50. The sheet processing device 60 includes the first cord holder 301, the second cord holder 302, and the third cord holder 303 to hold the power cord 55 at the position away from the feeding ports M1 and M2 disposed in the right side face 1d of the sheet separator 1 and the ejection port N of the lamination processing device 50.

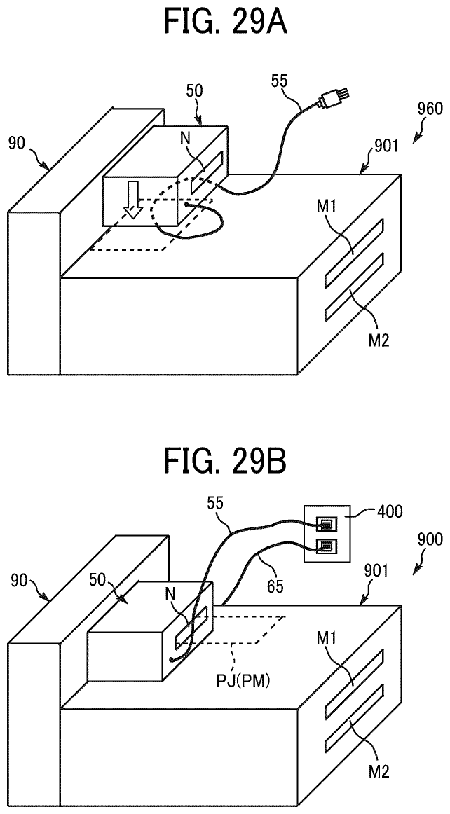

FIG. 29A is a schematic perspective view of a sheet processing system as a comparative example illustrating a lamination processing device being attached to a sheet processing device.

FIG. 29B is a schematic perspective view of the sheet processing system as a comparative example illustrating the lamination processing device attached to the sheet processing device.

Due to such a configuration, as in a known sheet processing system illustrated in FIG. 29A as a comparative example, when the lamination processing device 50 is attached to a sheet processing device 960 including a sheet separator 901 and the relay conveyor 90, an inconvenience that the power cord 55 of the lamination processing device 50 is caught between the lamination processing device 50 and (the sheet separator 901 of) the sheet processing device 960 can be prevented.

Further, as in a known sheet processing system 900 illustrated in FIG. 29B as a comparative example, an inconvenience that the power cord 55 of the lamination processing device 50 is arranged to cross the ejection port N (or the feeding ports M1 and M2) and the sheet ejection operation to eject the two-ply sheet PJ from the lamination processing device 50 (or an inconvenience that the sheet feeding operation to feed the two sheets P1 and P2 in the sheet processing device 60) can be prevented.

### Modification 5

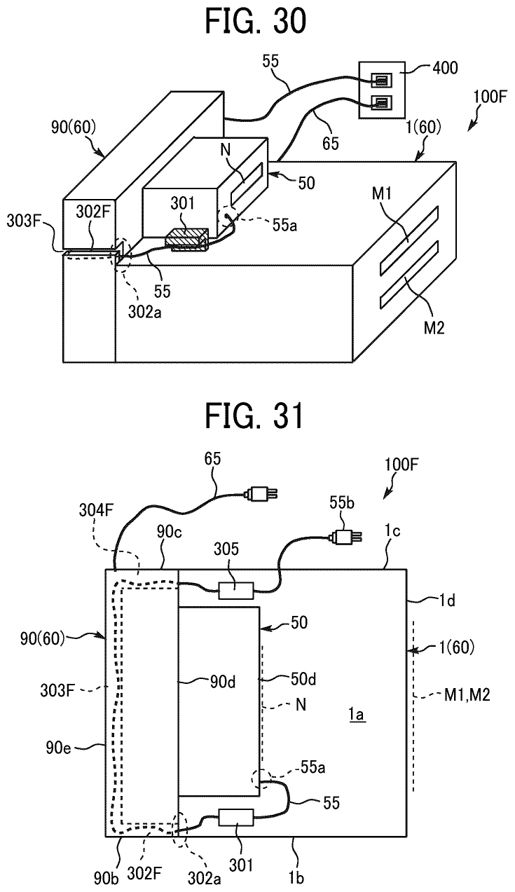

A description is given of a configuration of a sheet processing system 100F according to Modification 5 of the above-described embodiments of the present disclosure, with reference to FIGS. 30 and 31.

FIG. 30 is a schematic perspective view of the sheet processing system 100F according to Modification 5 of an embodiment of the present disclosure.

FIG. 31 is a schematic top view of the sheet processing system of FIG. 30.

As illustrated in FIGS. 30 and 31, the sheet processing system 100F according to Modification 5 includes a second cord holder 302F and a third cord holder 303F, which have different configurations from the second cord holder 302 and the third cord holder 303 of the sheet processing system 100E illustrated in FIG. 26.

In Modification 5, the second cord holder 302F is a recessed groove (an L-shaped groove) so as not to project from the front side face 90b of the relay conveyor 90 and has an opening 302a that is open in the right side face 90d of the relay conveyor 90.

The third cord holder 303F is also a recessed groove (an L-shaped groove) so as not to project from the left side face 90e of the relay conveyor 90 and is communicated with the second cord holder 302F on the side on which the front side face 90b and the left side face 90e intersect. The third cord holder 303F is communicated with a fourth cord holder 304F that is a recessed groove from the front side face 90b toward the rear side face 90c on the left side face 90e of the relay conveyor 90.

The power cord 55 of the lamination processing device 50 is extended from the root portion 55a of the power cord 55 via the position of the first cord holder 301, inserted into the second cord holder 302F from the opening 302a, held by the second cord holder 302F and the third cord holder 303F, arranged on the rear side face 90c (the fourth cord holder 304F), and connected to the commercial power supply 400.

Even in this configuration, it is less likely to cause an inconvenience that the power cord 55 of the lamination processing device 50 is caught between the lamination processing device 50 and the sheet processing device 60 when the lamination processing device 50 is attached to the sheet processing device 60 or an inconvenience that the power cord 55 of the lamination processing device 50 hinders the sheet feeding operation of the two sheets P1 and P2 in the sheet processing device 60 or the sheet ejection operation of the two-ply sheet PJ from the lamination processing device 50.

In particular, in Modification 5, the second cord holder 302F and the third cord holder 303F are formed not to be projected from the front side face 90b and the left side face 90e, respectively, of the relay conveyor 90. Accordingly, the overall size of the sheet processing system 100 F can be reduced in size to be more compact.

### Modification 6

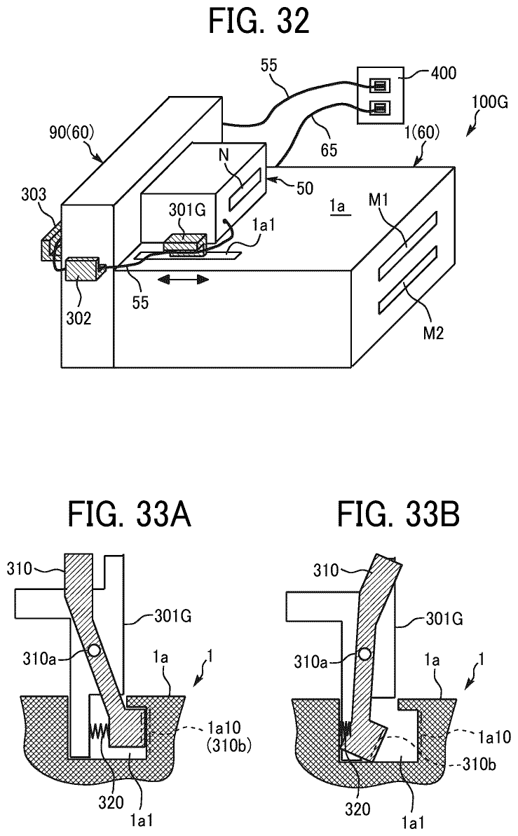

A description is given of a configuration of a sheet processing system 100G according to Modification 6 of the above-described embodiments of the present disclosure, with reference to FIGS. 32, 33A, and 33B.

FIG. 32 is a schematic perspective view of the sheet processing system 100G according to Modification 6 of an embodiment of the present disclosure.

FIGS. 33A and 33B are cross-sectional views, each illustrating an area including a first cord holder of the sheet processing system 100G of FIG. 32.

As illustrated in FIGS. 32, 33A, and 33B, the sheet processing system 100G according to Modification 6 can change the position to install a cord holder in the sheet processing device 60.

Specifically, in Modification 6, the first cord holder 301 of the three cord holders (i.e., the first cord holder 301, the second cord holder 302, and the third cord holder 303) can change the position manually in the left-and-right direction.

A groove 1a1 is disposed on the upper face 1a of the sheet separator 1 and extending in the left-and-right direction on the front side face 1b. A rack 1a10 that extends in the left-and-right direction is disposed in the groove 1a1. The left-and-right direction corresponds to a direction from the right side face to the left side face and orthogonal to the drawing sheet of FIGS. 33A and 33B.

On the other hand, a first cord holder 301G includes a link operation unit 310 that is rotatable around a support shaft 310a. The link operation unit 310 has one end (a portion to be inserted into the groove 1a1) connected to one end of a compression spring 320. The other end of the compression spring 320 is connected to one end (a portion to be inserted into the groove 1a1) of the first cord holder 301G. A fixed pinion 310b that can be fitted to the rack 1a10 of the groove 1a1 is formed at the one end of the link operation unit 310.

With this configuration, as illustrated in FIGS. 33A and 33B, when the link operation unit 310 is operated, by a user, to be rotated around the support shaft 310a in the clockwise direction against the biasing force of the compression spring 320, the rack 1a10 and the fixed pinion 310b are disengaged from each other, so that the first cord holder 301G can move in the left-and-right direction. After the first cord holder 301G is moved to a desired position, as illustrated in FIG. 33A, as the user releases the hand from the link operation unit 310, the link operation unit 310 rotates around the support shaft 310a in the counterclockwise direction due to the biasing force of the compression spring 320. By so doing, the rack 1a10 and the first cord holder 301 are fitted to each other, so as to determine the position of the first cord holder 301G in the left-and-right direction.

Since the position of the first cord holder 301G can be changed, the retention of the power cord 55 by the first cord holder 301G can be flexibly adjusted.

In Modification 6, only the first cord holder 301G of the three cord holders (i.e., the first cord holder 301G, the second cord holder 302, and the third cord holder 303) can change the position. However, the positions of the second cord holder 302 and the third cord holder 303 may be changeable.

### Modification 7

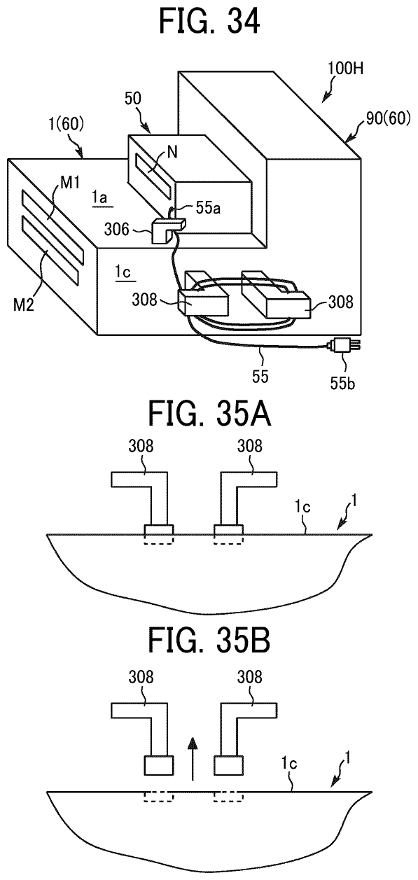

A description is given of a configuration of a sheet processing system 100H according to Modification 7 of the above-described embodiments of the present disclosure, with reference to FIGS. 34, 35A, 35B, 36A, and 36B.

FIG. 34 is a schematic perspective view of a sheet processing system 100H according to Modification 7 of the above-described embodiments of the present disclosure.

FIGS. 35A and 35B are top views, each illustrating an area including cord winding portions of the sheet processing system 100H of FIG. 34.

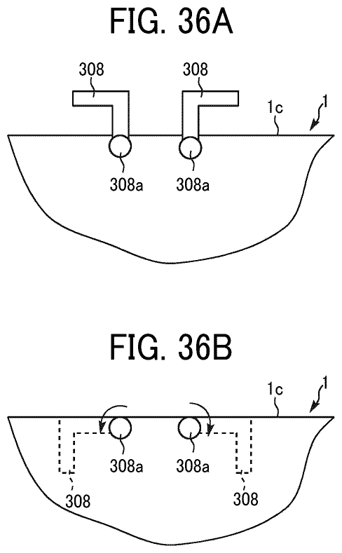

FIGS. 36A and 36B are top views, each illustrating the cord winding portions, according to another embodiment of the present disclosure.

As illustrated in FIGS. 34, 35A, and 35B, the sheet processing system 100H according to Modification 7 includes cord winding portions 308 provided with the sheet processing device 60. Each of the cord winding portions 308 is a cord winder around which the power cord 55 of the lamination processing device 50 is wound.

Specifically, the cord winding portions 308 are a pair of L-shaped members projecting backward from the rear side face 1c of the sheet separator 1 and symmetrically disposed facing each other. As illustrated in FIG. 34, the power cord 55 having the root portion 55a located on the rear side face of the lamination processing device 50 is held by a cord holder 360 disposed at the rear side position on the upper face 1a of the sheet separator 1 and is inserted into the commercial power supply 400 with no large slack in a state where the excess cord is wound around the cord winding portions 308. In Modification 7, the power cord 65 of the sheet processing device 60 may be wound around the cord winding portions 308.

Even in this configuration, it is less likely to cause an inconvenience that the power cord 55 of the lamination processing device 50 is caught between the lamination processing device 50 and the sheet processing device 60 when the lamination processing device 50 is attached to the sheet processing device 60 or an inconvenience that the power cord 55 of the lamination processing device 50 hinders the sheet feeding operation of the two sheets P1 and P2 in the sheet processing device 60 or the sheet ejection operation of the two-ply sheet PJ from the lamination processing device 50.

As illustrated in FIGS. 35A and 35B, in Modification 7, the cord winding portions 308 are detachably attached to the sheet processing device 60. Specifically, the cord winding portions 308 may be attached to the rear side face 1c of the sheet separator 1 as illustrated in FIG. 35A or may be detached from the rear side face 1c of the sheet separator 1 as illustrated in FIG. 35B. With this configuration, when the power cord 55 does not need to be wound, the cord winding portions 308 can be removed from the sheet processing device 60. For example, screws may be used to fix the cord winding portions 308 to the sheet processing device 60. In Modification 7, as illustrated in FIGS. 36A and 36B, the cord winding portions 308 may be retractable to the sheet processing device 60. Specifically, the cord winding portions 308 may be rotated around hinges 308a (for example, a known hinge assembly) to project from the rear side face 1c of the sheet separator 1, as illustrated in FIG. 36A, or may be rotated around the hinges 308a not to project from the rear side face 1c of the sheet separator 1, as illustrated in FIG. 36B. With this configuration, when the power cord 55 does not need to be wound, the cord winding portions 308 can be accommodated in an accommodation portion (a portion having a recess inside the device) of the sheet processing device 60 so that the cord winding portions 308 do not project from the sheet processing device 60.

As described above, the sheet processing system 100 according to the above-described embodiments includes the sheet processing device 60 that performs the sheet separating operation and the sheet inserting operation. More specifically, the sheet separator 1 of the sheet processing device 60 performs the sheet separating operation to separate the non-bonding portion of the two-ply sheet PJ in which two sheets, which are the first sheet P1 and the second sheet P2, are overlapped and bonded together at one end of the two-ply sheet PJ as the bonding portion A of the two-ply sheet PJ. The sheet separator 1 of the sheet processing device 60 then performs the sheet inserting operation to insert the inner sheet PM between the first sheet P1 and the second sheet P2 separated from each other in the sheet separating operation. The lamination processing device 50 performs the sheet laminating operation on the two-ply sheet PJ with the inner sheet PM enclosed between the first sheet P1 and the second sheet P2 that are separated by the sheet separator 1. The sheet processing device 60 includes the first cord holder 301, the second cord holder 302, and the third cord holder 303 that hold the power cord 55 extending from the lamination processing device 50, at the position that does not hinder the sheet feeding operation on the two sheets P1 and P2 to be fed to the sheet processing device 60 and the sheet ejecting operation on the laminated two-ply sheet PJ ejected from the lamination processing device 50.

Due to such a configuration, it is less likely to cause an inconvenience that the power cord 55 of the lamination processing device 50 is caught between the lamination processing device 50 and the sheet processing device 60 when the lamination processing device 50 is attached to the sheet processing device 60 or an inconvenience that the power cord 55 of the lamination processing device 50 hinders the sheet feeding operation of the two sheets P1 and P2 in the sheet processing device 60 or the sheet ejection operation of the two-ply sheet PJ from the lamination processing device 50.

The above-described embodiments of the present disclosure are applied to the sheet processing device 60 with the relay conveyor 90 attached to the left side face of the sheet separator 1. However, the present disclosure is not limited to the above-described sheet processing device (such as the sheet processing device 60). For example, the present disclosure is also applicable to a sheet processing device with a relay conveyor attached to the right side face of a sheet separator (for example, the sheet processing device 60 illustrated in FIG. 26, disposed with the left and right reversed. In this case, the feeding ports M1 and M2 and the ejection port N are disposed on the left side face of the device, the third cord holder 303 is disposed on the right side face of the device, and the root portion 55a of the power cord 55 is disposed on the left side face of the device.

The root portion 55a of the power cord 55 may be provided on the front side of the device.

Even in such a configuration, the same effect as the configuration according to the present embodiment can be achieved.

The present disclosure is not limited to the above-described embodiment and variations, and the configuration of the present embodiment can be appropriately modified other than suggested in the above embodiment and variations within a scope of the technological concept of the present disclosure. For example, the number, position, shape, and so on of the above-described components are not limited to the number, position, shape, and so on of the above-described embodiment unless in particular specified but may be, for example, any suitable number, position, and shape.

In the specification of the present disclosure, “upper face”, “rear side face”, “front side face”, “right side face”, and “left side face” are not limited to a continuous flat face, but indicate a relation of rough faces constituting a solid, and are defined to include, for example, a face including unevenness, a hole, or a notch, a face on which another member is installed, and a plurality of faces (including a curved face).

The present disclosure may be applicable to, for example, a combination of the following Aspects 1 to 40.

### Aspect 1

In Aspect 1, a sheet processing system (for example, the sheet processing system 100) includes a sheet processing device (for example, the sheet processing device 60), a lamination processing device (for example, the lamination processing device 50), and a sheet feeder (for example, the bypass sheet feeder 91, the bypass tray 94). The sheet processing device includes a sheet separator (for example, the sheet separator 1) and a relay conveyor (for example, the relay conveyor 90). The sheet separator performs a sheet separating operation of separating a non-bonding portion of a two-ply sheet (for example, the two-ply sheet PJ) in which two sheets (for example, the first sheet P1, the second sheet P2) are overlapped and bonded together at a bonding portion (for example, the bonding portion A) of the two-ply sheet, and a sheet inserting operation of inserting an inner sheet (for example, the inner sheet PM) between the two sheets of the two-ply sheet separated in the sheet separating operation to form a first enclosed two-ply sheet (for example, the two-ply sheet PJ). The relay conveyor is disposed downstream from the sheet separator in a sheet conveyance direction to convey the first enclosed two-ply sheet from the sheet separator. The lamination processing device performs a sheet laminating operation of bonding the two sheets separated by the sheet separator, on the first enclosed two-ply sheet conveyed by the relay conveyor subjected to the sheet inserting operation, with the inner sheet inserted between the two sheets. The sheet feeder feeds a second enclosed two-ply sheet (the bypass two-ply sheet PJ′) enclosing an inner sheet between two sheets, to the lamination processing device without conveying the second enclosed two-ply sheet through the sheet processing device.

### Aspect 2

In Aspect 2, in the sheet processing system according to Aspect 1, the lamination processing device includes a thermal pressure roller pair (for example, the thermal pressure roller pair 51) to apply heat and pressure to the first enclosed two-ply sheet and the second enclosed two-ply sheet, and a conveyance roller pair (for example, the sixth conveyance roller pair 9) to convey the first enclosed two-ply sheet conveyed through the relay conveyor or the second enclosed two-ply sheet placed on the sheet feeder, toward the thermal pressure roller pair.

### Aspect 3

In Aspect 3, in the sheet processing system according to Aspect 2, the thermal pressure roller pair and the conveyance roller pair are rotatable at a same timing in a reverse direction to a rotational direction in operation while the operation of the sheet processing system is stopped.

### Aspect 4

In Aspect 4, in the sheet processing system according to any one of Aspects 1 to 3, the sheet processing device and the lamination processing device perform are operable in an automatic mode, the sheet conveying device and the lamination processing device are operable in a manual mode, and an operation in the sheet processing system is changeable between the automatic mode and the manual mode are changeable.

### Aspect 5

In Aspect 5, in the sheet processing system according to Aspect 4, the automatic mode is executed when the relay conveyor contacts or approaches the sheet separator and the lamination processing device in response to a rotation of at least a part of the relay conveyor around a shaft in a given direction, and the manual mode is executed when the relay conveyor the at least the part of the relay conveyor around the shaft in a reverse direction that is opposite to the given direction.

### Aspect 6

In Aspect 6, in the sheet processing system according to Aspect 5, the sheet conveying device is a part of the relay conveyor rotated around the shaft.

### Aspect 7

In Aspect 7, in the sheet processing system according to Aspect 4, the automatic mode is executed when the relay conveyor contacts or approaches the sheet separator and the lamination processing device in response to movement of the relay conveyor in a given direction, and the manual mode is executed when the relay conveyor is separated from the sheet separator and the lamination processing device in response to movement of the relay conveyor in a reverse direction that is opposite to the given direction.

### Aspect 8

In Aspect 8, in the sheet processing system according to Aspect 7, the sheet conveying device is a bypass tray (for example, the bypass tray 94) detachably attached to the lamination processing device, and the bypass tray is detachable after the relay conveyor is separated from the sheet separator and the lamination processing device.

### Aspect 9

In Aspect 9, in the sheet processing system according to any one of Aspects 4 to 8, the relay conveyor is positioned, in the automatic mode, at least one of the sheet separator or the lamination processing device.

### Aspect 10

In Aspect 10, in the sheet processing system according to any one of Aspects 1 to 9, the lamination processing device is detachably attached to the sheet processing device.

### Aspect 11

In Aspect 11, a sheet processing system (for example, the sheet processing system 100E) includes a sheet processing device (for example, the sheet processing device 60) and a lamination processing device (for example, the lamination processing device 50). The sheet processing device includes a sheet separator (for example, the sheet separator 1) that performs a sheet separating operation of separating a non-bonding portion of a two-ply sheet (for example, the two-ply sheet PJ) in which two sheets (for example, the first sheet P1, the second sheet P2) are overlapped and bonded together at a bonding portion (for example, the bonding portion A) of the two-ply sheet, and a sheet inserting operation of inserting an inner sheet (for example, the inner sheet PM) between the two sheets of the two-ply sheet separated in the sheet separating operation. The lamination processing device performs a sheet laminating operation of bonding the two sheets of the two-ply sheet as an enclosed two-ply sheet after the sheet inserting operation, with the enclosed two-ply sheet having the inner sheet enclosed between the two sheets separated by the sheet separator. The lamination processing device includes a power cord (for example, the power cord 55). The sheet processing device includes a cord holder (for example, the first cord holder 301, the second cord holder 302, and the third cord holder 303) to hold the power cord extending from the lamination processing device at a position where a sheet feeding operation of the two sheets to be conveyed to the sheet processing device and a sheet ejecting operation of the enclosed two-ply sheet PJ to be ejected from the lamination processing device after the sheet laminating operation are not hindered.

### Aspect 12

In Aspect 12, in the sheet processing system according to claim 11, the sheet processing device further includes a relay conveyor (for example, the relay conveyor 90) downstream from the sheet separator in a sheet conveyance direction to convey the first enclosed two-ply sheet from the sheet separator toward the lamination processing device, the lamination processing device is detachably attached to an upper face (for example, the upper face 1a) of the sheet separator, the relay conveyor has a projected portion disposed at a position higher than the top face of the sheet separator on a side face of the sheet separator, and the projected portion of the relay conveyor is coupled to the lamination processing device.

### Aspect 13

In Aspect 13, in the sheet processing system according to Aspect 12, where a face that is opposite to a commercial power supply (for example, the commercial power supply 400) to which the power cord is connected is represented as a rear side face, a face that is opposite to the rear side face is represented as a front side face, a face that is on the right side from the front side face is represented as a right side face, and a face that is on the left side from the front side face is represented to as a left side face, the relay conveyor is disposed on the left side face or the right side face of the sheet separator and the lamination processing device, an ejection port (for example, the ejection port N) through which the two-ply sheet subjected to the sheet laminating operation is ejected is disposed on the right side face or the left side face of the lamination processing device, a root portion (for example, the root portion 55a) of the power cord is disposed on any one of the right side face, the left side face, and the front side face of the lamination processing device at a position close to the front side face from the ejection port, the sheet processing device includes multiple cord holders including the cord holder, and the multiple cord holders include a first cord holder (for example, the first cord holder 301) on an upper face of the sheet separator at a position close to the front side face from the lamination processing device, a second cord holder (for example, the second cord holder 302) on a front side face of the relay conveyor, and a third cord holder (for example, the third cord holder 303) on the left side face or the right side face of the relay conveyor.

### Aspect 14

In Aspect 14, in the sheet processing system according to Aspect 13, the first cord holder is an L-shaped member projecting upward from the upper face.

### Aspect 15

In Aspect 15, in the sheet processing system according to Aspect 13 or 14, the second holder is a recessed groove so as not to project from the front side face of the relay conveyor and has an opening (for example, the opening 302a) that is open in the right side face or the left side face of the relay conveyor, the third cord holder is a recessed groove so as not to project from the left side face or the right side face of the relay conveyor and is communicated with the second cord holder, and the power cord is inserted into the second cord holder from the opening and held by the second cord holder and the third cord holder.

### Aspect 16

In Aspect 16, in the sheet processing system according to Aspect 13, at least one of the second cord holder or the third cord holder is an L-shaped member projecting upward from the upper face.

### Aspect 17

In Aspect 17, in the sheet processing system according to any one of Aspects 11 to 16, the cord holder is variably positioned in the sheet processing device.

### Aspect 18

In Aspect 18, in the sheet processing system according to any one of Aspects 11 to 17, the sheet processing device further includes a cord winding portion (for example, the cord winding portions 308) around which the power cord is windable.

### Aspect 19

In Aspect 19, in the sheet processing system according to Aspect 18, the cord winding portion is detachably or retractably disposed with respect to the sheet processing device.

### Aspect 20

In Aspect 20, in the sheet processing system according to any one of Aspects 11 to 19, the lamination processing device is detachably attached to the sheet processing device.

### Aspect 21

In Aspect 21, a sheet processing system (for example, the sheet processing system 100) includes a sheet processing device (for example, the sheet processing device 60), a lamination processing device (for example, the lamination processing device 50), and a relay conveyor (for example, the relay conveyor 90). The sheet processing device includes a sheet separator (for example, the sheet separator 1) to separate a non-bonding portion of a two-ply sheet (for example, the two-ply sheet PJ) having two sheets (for example, the first sheet P1, the second sheet P2) overlapped and bonded together at a bonding portion (for example, the bonding portion A), and insert an inner sheet between the two sheets of the two-ply sheet separated to form a first enclosed two-ply sheet (for example, the bypass two-ply sheet PJ′). The lamination processing device bonds the two sheets of the first enclosed two-ply sheet, and bonds the two sheets of a second enclosed two-ply sheet in which the inner sheet is inserted between the two sheets of the second enclosed two-ply sheet disposed outside the sheet separator. The relay conveyor is disposed downstream from the sheet separator and upstream from the lamination processing device in a sheet conveyance direction to convey the first enclosed two-ply sheet from the sheet separator to the lamination processing device. The lamination processing device is attachable a sheet feeder (for example, the bypass sheet feeder 91, the bypass tray 94) to directly feed the second enclosed two-ply sheet to the lamination processing device.

### Aspect 22

In Aspect 22, in the sheet processing system according to Aspect 21, the lamination processing device includes a thermal pressure roller pair (for example, the thermal pressure roller pair 51) and a conveyance roller pair (for example, the sixth conveyance roller pair 9). The thermal pressure roller pair applies heat and pressure to the first enclosed two-ply sheet and the second enclosed two-ply sheet. The conveyance roller pair conveys the first enclosed two-ply sheet conveyed from the relay conveyor to the thermal pressure roller pair or conveys the second enclosed two-ply sheet conveyed from the sheet feeder to the thermal pressure roller pair.

### Aspect 23

In Aspect 23, in the sheet processing system according to Aspect 22, the thermal pressure roller pair and the conveyance roller pair are rotatable in a forward direction to apply heat and pressure to the first enclosed two-ply sheet and the second enclosed two-ply sheet, and rotatable in a reverse direction opposite to the forward direction to convey the second enclosed two-ply sheet to the sheet feeder in response to a stop operation of the sheet processing system.

### Aspect 24

In Aspect 24, the sheet processing system according to any one of Aspects 21 to 23 further includes circuitry (for example, the controller 500) to control the sheet processing device and the lamination processing device to perform an automatic mode to feed the first enclosed two-ply sheet from the sheet processing device to the lamination processing device through the relay conveyor, control the lamination processing device to perform a manual mode to directly feed the second enclosed two-ply sheet from the sheet feeder to the lamination processing device, and change an operation of the sheet processing system between the automatic mode and the manual mode.

### Aspect 25

In Aspect 25, in the sheet processing system according to Aspect 24, the relay conveyor is rotatable around a shaft in a first direction toward the sheet separator to contact or to be adjacent to the sheet separator and in a second direction away from the sheet separator, and the circuitry is to perform the automatic mode when the relay conveyor contacts or is adjacent to the sheet separator, and perform the manual mode when the relay conveyor is away from the sheet separator.

### Aspect 26

In Aspect 26, in the sheet processing system according to Aspect 25, the sheet feeder rotatable around the shaft of the relay conveyor.

### Aspect 27

In Aspect 27, in the sheet processing system according to Aspect 24, the relay conveyor is detachably attached to the sheet separator, and the circuitry is to perform the automatic mode when the relay conveyor is attached to the sheet separator, and perform the manual mode when the relay conveyor is detached from the sheet separator.

### Aspect 28

In Aspect 28, in the sheet processing system according to Aspect 27, the sheet feeder is detachably attached to the lamination processing device from which the relay conveyor is separated.

### Aspect 29

In Aspect 29, in the sheet processing system according to any one of Aspects 24 to 28, the relay conveyor is attached to at least one of the sheet separator or the lamination processing device in the automatic mode.

### Aspect 30

In Aspect 10, in the sheet processing system according to any one of Aspects 21 to 29, the lamination processing device is detachably attached to the sheet processing device.

### Aspect 31

In Aspect 31, a sheet processing system (for example, the sheet processing system 100E) includes a sheet processing device (for example, the sheet processing device 60) and a lamination processing device (for example, the lamination processing device 50). The sheet processing device includes a sheet separator (for example, the sheet separator 1) and a cord holder (for example, the first cord holder 301, the second cord holder 302, and the third cord holder 303). The sheet separator separates a non-bonding portion of a two-ply sheet (for example, the two-ply sheet PJ) having two sheets (for example, the first sheet P1, the second sheet P2) overlapped and bonded together at a bonding portion (for example, the bonding portion A), and inserts an inner sheet (for example, the inner sheet PM) between the two sheets of the two-ply sheet separated to form an enclosed two-ply sheet. The lamination processing device includes a power cord (for example, the power cord 55) and bonds the two sheets of the enclosed two-ply sheet. The sheet separator has a feeding port from which the two sheets and the inner sheet are fed and disposed on one of side faces of the sheet separator, and a feeding area in the vicinity of the feeding port. The lamination processing device has an ejection port from which the enclosed two-ply sheet bonded by the lamination processing device is ejected, and an ejection area in the vicinity of the ejection port. The cord holder holds the power cord to be extended outside the feeding area and the ejection area.

### Aspect 32

In Aspect 32, in the sheet processing system according to claim 31, the sheet processing device further includes a relay conveyor (for example, the relay conveyor 90) downstream from the sheet separator in a sheet conveyance direction to convey the enclosed two-ply sheet from the sheet separator and upstream from the lamination processing device in a sheet conveyance direction to convey the enclosed two-ply sheet from the sheet separator toward the lamination processing device. The lamination processing device is detachably attached to an upper face (for example, the upper face 1a) of the sheet separator. The relay conveyor has a projected portion projected above the upper face of the sheet separator on another of the side faces of the sheet separator. The projected portion of the relay conveyor is coupled to the lamination processing device.

### Aspect 33

In Aspect 33, in the sheet processing system according to Aspect 32, the relay conveyor has a first side face on said another of the side faces of the sheet separator, the lamination processing device has the ejection port on a first side face of the lamination processing device opposite to a second side face of the lamination processing device coupled to the projected portion of the relay conveyor, the power cord has a root portion on the one of side faces of the lamination processing device, and the root portion is adjacent to a front side face of the lamination processing device. The sheet processing device includes multiple cord holders including a first cord holder (for example, the first cord holder 301), a second cord holder (for example, the second cord holder 302), and a third cord holder (for example, the third cord holder 303). The first cord holder is on the upper face of the sheet separator and adjacent to the front side face of the lamination processing device. The second cord holder is on a front side face of the relay conveyor. The third cord holder is on a second side face of the relay conveyor opposite to the first side face and adjacent to the front side face of the relay conveyor.

### Aspect 34

In Aspect 34, in the sheet processing system according to Aspect 33, the first cord holder is an L-shaped member projecting upward from the upper face.

### Aspect 35

In Aspect 35, in the sheet processing system according to Aspect 33 or 34, the second cord holder has a first recessed groove recessed from the front side face of the relay conveyor, the third cord holder has a second recessed groove recessed from the second side face of the relay conveyor, the second recessed groove communicating with the first recessed groove, and the power cord is inserted into the first recessed groove of the second cord holder and the second recessed groove of the third cord holder.

### Aspect 36

In Aspect 36, in the sheet processing system according to Aspect 33, at least one of the second cord holder or the third cord holder is an L-shaped member projecting upward from the upper face.

### Aspect 37

In Aspect 37, in the sheet processing system according to any one of Aspects 31 to 36, the cord holder is slidably movable to change a position of the cord holder in the sheet processing device.

### Aspect 38

In Aspect 38, in the sheet processing system according to any one of Aspects 31 to 37, the sheet processing device further includes a cord winding portion (for example, the cord winding portions 308) around which the power cord is windable.

### Aspect 39

In Aspect 19, in the sheet processing system according to Aspect 38, the cord winding portion is detachably or retractably disposed with respect to the sheet processing device.

### Aspect 40

In Aspect 40, in the sheet processing system according to any one of Aspects 31 to 39, the lamination processing device is detachably attached to the sheet processing device.

The present disclosure is not limited to specific embodiments described above, and numerous additional modifications and variations are possible in light of the teachings within the technical scope of the appended claims. It is therefore to be understood that, the disclosure of this patent specification may be practiced otherwise by those skilled in the art than as specifically described herein, and such, modifications, alternatives are within the technical scope of the appended claims. Such embodiments and variations thereof are included in the scope and gist of the embodiments of the present disclosure and are included in the embodiments described in claims and the equivalent scope thereof.

The effects described in the embodiments of this disclosure are listed as the examples of preferable effects derived from this disclosure, and therefore are not intended to limit to the embodiments of this disclosure.

The embodiments described above are presented as an example to implement this disclosure. The embodiments described above are not intended to limit the scope of the invention. These novel embodiments can be implemented in various other forms, and various omissions, replacements, or changes can be made without departing from the gist of the invention. These embodiments and their variations are included in the scope and gist of this disclosure and are included in the scope of the invention recited in the claims and its equivalent.

Any one of the above-described operations may be performed in various other ways, for example, in an order different from the one described above.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions.

What is claimed is:

1. A sheet processing system comprising:
a sheet processing device including
a sheet separator to:
separate a non-bonding portion of a two-ply sheet having two sheets overlapped and bonded together at a bonding portion; and,
insert an inner sheet between the two sheets of the two-ply sheet separated to form a first enclosed two-ply sheet; and
a lamination processing device to:
bond the two sheets of the first enclosed two-ply sheet; and
bond the two sheets of a second enclosed two-ply sheet, in which the inner sheet is inserted between the two sheets of the second enclosed two-ply sheet disposed outside the sheet separator; and
a relay conveyor downstream from the sheet separator and upstream from the lamination processing device in a sheet conveyance direction to convey the first enclosed two-ply sheet from the sheet separator to the lamination processing device,
wherein the lamination processing device is attachable to a sheet feeder to directly feed the second enclosed two-ply sheet to the lamination processing device.

2. The sheet processing system according to claim 1,
wherein the lamination processing device includes:
a thermal pressure roller pair to apply heat and pressure to the first enclosed two-ply sheet and the second enclosed two-ply sheet; and
a conveyance roller pair to:
convey the first enclosed two-ply sheet conveyed from the relay conveyor to the thermal pressure roller pair; or
convey the second enclosed two-ply sheet conveyed from the sheet feeder to the thermal pressure roller pair.

3. The sheet processing system according to claim 2,
wherein the thermal pressure roller pair and the conveyance roller pair are:
rotatable in a forward direction to apply heat and pressure to the first enclosed two-ply sheet and the second enclosed two-ply sheet; and
rotatable in a reverse direction opposite to the forward direction to convey the second enclosed two-ply sheet to the sheet feeder in response to a stop operation of the sheet processing system.

4. The sheet processing system according to claim 1, further comprising circuitry configured to:
control the sheet processing device and the lamination processing device to perform an automatic mode to feed the first enclosed two-ply sheet from the sheet processing device to the lamination processing device through the relay conveyor;
control the lamination processing device to perform a manual mode to directly feed the second enclosed two-ply sheet from the sheet feeder to the lamination processing device; and
change an operation of the sheet processing system between the automatic mode and the manual mode.

5. The sheet processing system according to claim 4,
wherein the relay conveyor is rotatable around a shaft:
in a first direction toward the sheet separator to contact or to be adjacent to the sheet separator; and
in a second direction away from the sheet separator, and
the circuitry is configured to:
perform the automatic mode when the relay conveyor contacts or is adjacent to the sheet separator; and
perform the manual mode when the relay conveyor is away from the sheet separator.

6. The sheet processing system according to claim 5,
wherein the sheet feeder rotatable around the shaft of the relay conveyor.

7. The sheet processing system according to claim 4,
wherein the relay conveyor is detachably attached to the sheet separator; and
the circuitry is configured to:
perform the automatic mode when the relay conveyor is attached to the sheet separator; and
perform the manual mode when the relay conveyor is detached from the sheet separator.

8. The sheet processing system according to claim 7,
wherein the sheet feeder is detachably attached to the lamination processing device from which the relay conveyor is separated.

9. The sheet processing system according to claim 4,
wherein the relay conveyor is attached to at least one of the sheet separator or the lamination processing device in the automatic mode.

10. The sheet processing system according to claim 1,
wherein the lamination processing device is detachably attached to the sheet processing device.

11. A sheet processing system comprising:
a sheet processing device including
a sheet separator to:
separate a non-bonding portion of a two-ply sheet having two sheets overlapped and bonded together at a bonding portion; and,
insert an inner sheet between the two sheets of the two-ply sheet separated to form an enclosed two-ply sheet; and
a cord holder; and
a lamination processing device including a power cord, the lamination processing device to bond the two sheets of the enclosed two-ply sheet,
wherein the sheet separator has:
a feeding port from which the two sheets and the inner sheet are fed, the feeding port on one of side faces of the sheet separator; and
a feeding area in the vicinity of the feeding port, the lamination processing device has:
an ejection port from which the enclosed two-ply sheet bonded by the lamination processing device is ejected; and
an ejection area in the vicinity of the ejection port, and
the cord holder holds the power cord to be extended outside the feeding area and the ejection area.

12. The sheet processing system according to claim 11,
wherein the sheet processing device further includes a relay conveyor downstream from the sheet separator and upstream from the lamination processing device in a sheet conveyance direction to convey the enclosed two-ply sheet from the sheet separator toward the lamination processing device,
the lamination processing device is detachably attached to an upper face of the sheet separator,
the relay conveyor has a projected portion projected above the upper face of the sheet separator on another of the side faces of the sheet separator, and
the projected portion of the relay conveyor is coupled to the lamination processing device.

13. The sheet processing system according to claim 12,
wherein the relay conveyor has a first side face on said another of the side faces of the sheet separator,
the lamination processing device has the ejection port on a first side face of the lamination processing device opposite to a second side face of the lamination processing device coupled to the projected portion of the relay conveyor,
the power cord has a root portion on the one of side faces of the lamination processing device,
the root portion is adjacent to a front side face of the lamination processing device, and
the sheet processing device includes multiple cord holders including:
a first cord holder on the upper face of the sheet separator, the first cord holder adjacent to the front side face of the lamination processing device,
a second cord holder on a front side face of the relay conveyor, and
a third cord holder on a second side face of the relay conveyor opposite to the first side face and adjacent to the front side face of the relay conveyor.

14. The sheet processing system according to claim 13,
wherein the first cord holder is an L-shaped member projecting upward from the upper face.

15. The sheet processing system according to claim 13,
wherein the second cord holder has a first recessed groove recessed from the front side face of the relay conveyor,
the third cord holder has a second recessed groove recessed from the second side face of the relay conveyor, the second recessed groove communicating with the first recessed groove, and
the power cord is inserted into the first recessed groove of the second cord holder and the second recessed groove of the third cord holder.

16. The sheet processing system according to claim 13,
wherein at least one of the second cord holder or the third cord holder is an L-shaped member projecting upward from the upper face.

17. The sheet processing system according to claim 11,
wherein the cord holder is slidably movable to change a position of the cord holder in the sheet processing device.

18. The sheet processing system according to claim 11,
wherein the sheet processing device further includes a cord winding portion around which the power cord is windable.

19. The sheet processing system according to claim 18,
wherein the cord winding portion is:
detachably attached to the sheet processing device; or
accommodatable inside the sheet processing device.

20. The sheet processing system according to claim 11,
wherein the lamination processing device is detachably attached to the sheet processing device.
